(19) United States
(12) Patent Application Publication
(10) Pub. No.: US 2026/0187899 A1
(43) Pub. Date: Jul. 2, 2026

(54) DYNAMIC RELATIONSHIP-BASED AVATAR GARMENT GENERATION

(71) Applicant: Snap Inc., Santa Monica, CA (US)

(72) Inventor: Suraya Shivji, New York, NY (US)

(21) Appl. No.: 19/005,879

(22) Filed: Dec. 30, 2024

(51) Int. Cl. G06T 15/04; H04L 51/04

(52) U.S. Cl. CPC G06T 15/04; H04L 51/04

(57) ABSTRACT

The described system facilitates personalized avatar interactions by dynamically generating and displaying modified garments. The system determines the initiation of an interaction function by a first user with a second user within an interaction platform. It accesses avatar data for the first user, including visual attributes and a garment associated with the first avatar, as well as avatar data for the second user, including visual attributes and a garment associated with the second avatar. An image is generated featuring the first avatar wearing its garment alongside the second avatar wearing its garment. This image is applied to the first avatar's garment, creating a modified version that visually incorporates the second avatar. The system then displays the first avatar wearing the modified garment alongside the second avatar wearing its original garment, enabling enhanced user engagement through visually personalized and contextual representations of user interactions.

### TECHNICAL FIELD

The present disclosure relates generally to virtual avatars, and more specifically to dynamic relationship-based avatar garment generation.

### BACKGROUND

Avatars have gained popularity in recent years due to several factors that cater to the evolving needs of users in the digital world. Avatars enable users to create a digital representation of themselves, offering a unique and customized presence in online spaces. This personal touch allows users to express their identity and personality in a way that text cannot. Also, by representing themselves through an avatar, users can protect their real-life identity while still engaging with others in a meaningful way. Moreover, immersive experiences, such as virtual reality (VR) and augmented reality (AR) technologies, have driven demand for avatars that can interact in these environments. Their increasing adoption in various applications and platforms reflects the growing demand for more engaging and immersive digital experiences.

### BRIEF DESCRIPTION OF THE SEVERAL VIEWS OF THE DRAWINGS

In the drawings, which are not necessarily drawn to scale, like numerals may describe similar components in different views. To identify the discussion of any particular element or act more easily, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of an interaction system that has both client-side and server-side functionality, according to some examples.

FIG. 3 is a diagrammatic representation of a data structure as maintained in a database, according to some examples.

FIG. 4 illustrates an example method for dynamic avatar garment generation, according to some examples.

FIG. 5 illustrates a “best friends” interaction function, according to some examples.

FIG. 6 illustrates the first avatar wearing the modified garment a “best friends” t-shirt, according to some examples.

FIG. 7 illustrates a user interface whereby GPS data is used to generate the modified garment, according to some examples.

FIG. 8 illustrates a content augmentation displaying the modified t-shirt on a live camera feed, according to some examples.

FIG. 9 is a diagrammatic representation of a message, according to some examples.

FIG. 10 illustrates a system including a head-wearable apparatus with a selector input device, according to some examples.

FIG. 11 is a diagrammatic representation of a machine in the form of a computer system within which a set of instructions may be executed to cause the machine to perform any one or more of the methodologies discussed herein, according to some examples.

FIG. 12 is a block diagram showing a software architecture within which examples may be implemented.

FIG. 13 illustrates a machine-learning pipeline, according to some examples.

FIG. 14 illustrates training and use of a machine-learning program, according to some examples.

### DETAILED DESCRIPTION

Traditional systems for avatar interactions and personalized virtual garments often lack the dynamic, context-aware, and relationship-driven customization capabilities necessary to create highly personalized and meaningful user experiences. These systems typically provide pre-defined templates or static customization options for avatars and virtual garments, limiting the ability to reflect nuanced user relationships, shared activities, or real-world context in the designs.

One deficiency in these systems is their reliance on manual customization processes, requiring users to select and assemble garment designs without intelligent assistance or contextual relevance. Such static systems fail to account for dynamic factors like real-time interactions, geographic proximity, or shared memories between users. Additionally, traditional systems often do not integrate contextual data, such as historical activities, user preferences, or relationships, into the garment design process. This results in generic or impersonal designs that do not fully resonate with the user or their connections.

Another limitation is the inability to adapt designs dynamically based on evolving interactions, moods, or events. For instance, traditional systems typically cannot generate garments that reflect a recent shared activity or represent a time-sensitive event, such as a birthday or a group meetup. These systems also lack the infrastructure to leverage advanced technologies, such as machine learning models, to automate and enhance the personalization process, making the experience less engaging and tailored for users.

The interaction system described herein overcomes the deficiencies of traditional systems by introducing dynamic, context-aware, and relationship-driven customization for avatars and virtual garments. By leveraging advanced technologies, including machine learning models and real-time data processing, the system personalizes garment designs, transforming static interactions into meaningful and engaging experiences tailored to users'relationships, activities, and context.

Unlike traditional systems that rely on manual customization, the interaction system dynamically accesses user-specific data, such as avatar attributes, shared memories, and real-time proximity, to create personalized designs. For instance, the system identifies past activities or events shared between users, such as a trip or a group outing, and integrates contextual elements, like location names or thematic graphics, directly into the garment design. Additionally, it adapts in real-time to evolving interactions, moods, and events, ensuring that the designs remain relevant and reflective of users'current connections.

Moreover, the interaction system employs machine learning models to analyze historical data, preferences, and activity patterns, enabling automated generation of designs that resonate with users'interests and lifestyles. The integration of features like geolocation tracking further enhances the experience by unlocking location-based garments or coordinating designs for users in close proximity. These capabilities address the limitations of traditional systems by combining intelligence, context, and automation, fostering deeper emotional connections and enhancing user engagement.

When the effects in this disclosure are considered in aggregate, one or more of the methodologies described herein may improve known systems, providing additional functionality (such as, but not limited to, the functionality mentioned above), making them easier, faster, or more intuitive to operate, and/or obviating a need for certain efforts or resources that otherwise would be involved in an avatar process. Computing resources used by one or more machines, databases, or networks may thus be more efficiently utilized or even reduced.

### Networked Computing Environment

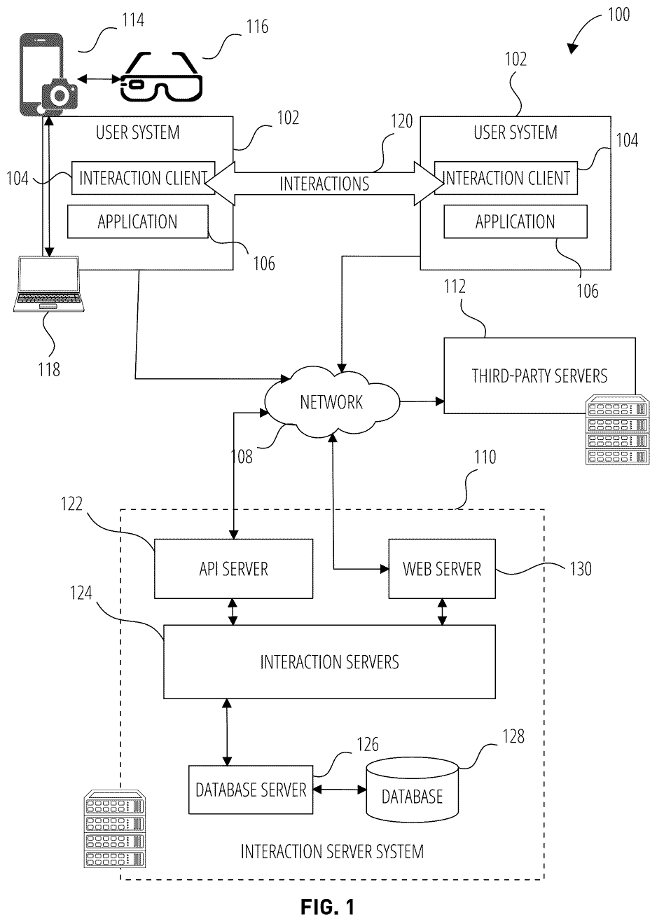

FIG. 1 is a block diagram showing an example interaction system 100 for facilitating interactions (e.g., exchanging text messages, conducting text audio and video calls, or playing games) over a network. The interaction system 100 includes multiple user systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), an interaction server system 110 and third-party servers 112). An interaction client 104 can also communicate with locally hosted applications 106 using Applications Programming Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the other interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, entity relationship information, and live event information. Data exchanges within the interaction system 100 are invoked and controlled through functions available via user interfaces (UIs) of the interaction clients 104.

Turning now specifically to the interaction server system 110, an API server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The API server 122 receives and transmits interaction data (e.g., commands and message payloads) between the interaction servers 124 and the user systems 102 (and, for example, interaction clients 104 and other application 106) and the third-party server 112. Specifically, the API server 122 provides a set of interfaces (e.g., routines and protocols) that can be called or queried by the interaction client 104 and other applications 106 to invoke functionality of the interaction servers 124. The API server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity relationship graph (e.g., the entity graph 310); the location of friends within an entity relationship graph; and opening an application event (e.g., relating to the interaction client 104).

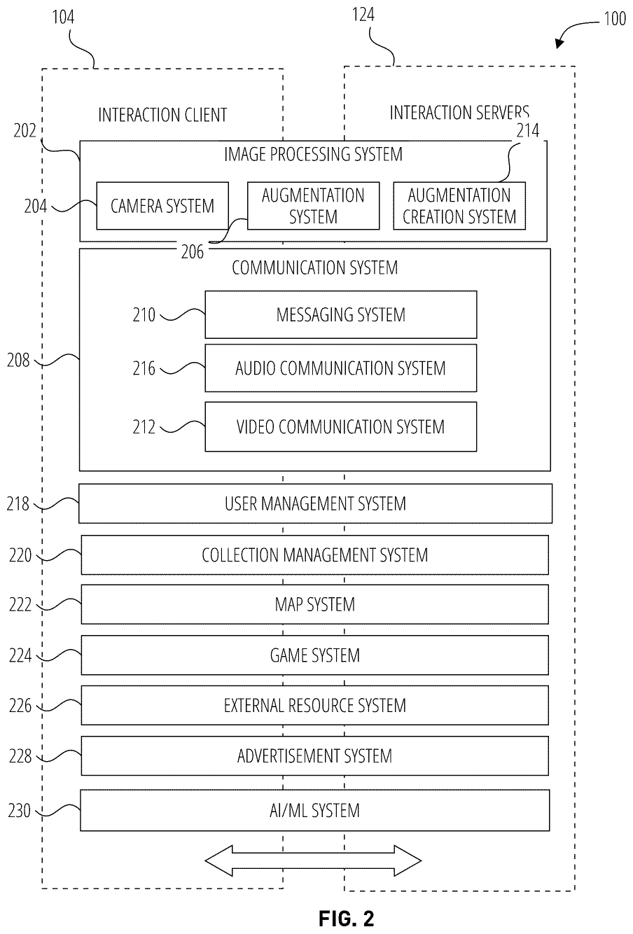

The interaction servers 124 hosts multiple systems and subsystems, described below with reference to FIG. 2.

### Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 104 determines whether the selected external resource is a web-based external resource or a locally installed application 106. In some cases, applications 106 that are locally installed on the user system 102 can be launched independently of and separately from the interaction client 104, such as by selecting an icon corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from third-party servers 112 for example, a markup-language document associated with the small-scale application and processing such a document.

In response to determining that the external resource is a locally installed application 106, the interaction client 104 instructs the user system 102 to launch the external resource by executing locally stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different applications 106 (or applets) can vary based on how the menu is launched by the user (e.g., from a conversation interface or from a non-conversation interface).

### System Architecture

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. In some examples, these subsystems are implemented as microservices. A microservice subsystem (e.g., a microservice application) may have components that enable it to operate independently and communicate with other services. Example components of a microservice subsystem may include:
Function logic: The function logic implements the functionality of the microservice subsystem, representing a specific capability or function that the microservice provides.
API interface: Microservices may communicate with other component through well-defined APIs or interfaces, using lightweight protocols such as REST or messaging. The API interface defines the inputs and outputs of the microservice subsystem and how it interacts with other microservice subsystems of the interaction system 100.
Data storage: A microservice subsystem may be responsible for its own data storage,

which may be in the form of a database, cache, or other storage mechanism (e.g., using the database server 126 and database 128). This enables a microservice subsystem to operate independently of other microservices of the interaction system 100.
Service discovery: Microservice subsystems may find and communicate with other microservice subsystems of the interaction system 100. Service discovery mechanisms enable microservice subsystems to locate and communicate with other microservice subsystems in a scalable and efficient way.
Monitoring and logging: Microservice subsystems may need to be monitored and logged in order to ensure availability and performance. Monitoring and logging mechanisms enable the tracking of health and performance of a microservice subsystem.

In some examples, the interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and augment (e.g., annotate or otherwise modify or edit) media content associated with a message.

A camera system 204 includes control software (e.g., in a camera application) that interacts with and controls camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from memory 1002 of a user system 102. These augmentations are selected by the augmentation system 206 and presented to a user of an interaction client 104, based on a number of inputs and data, such as for example:
Geolocation of the user system 102; and
Entity relationship information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system) that, based on duration and display parameters associated with a message or collection of messages (e.g., a story), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 308, entity graphs 310 and profile data 302) regarding users and relationships between users of the interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the interaction system 100. The interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes APIs with functions that can be called or invoked by the web-based application. The interaction servers 124 hosts a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a graphical user interface (GUI) of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and also handles the delivery and presentation of these advertisements.

An artificial intelligence and machine learning system 230 provides a variety of services to different subsystems within the interaction system 100. For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the augmentation system 206 to generate augmented content and augmented reality experiences, such as adding virtual objects or animations to real-world images. The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the interaction server system 110. The artificial intelligence and machine learning system 230 may also work with the audio communication system 216 to provide speech recognition and natural language processing capabilities, allowing users to interact with the interaction system 100 using voice commands.

### Data Architecture

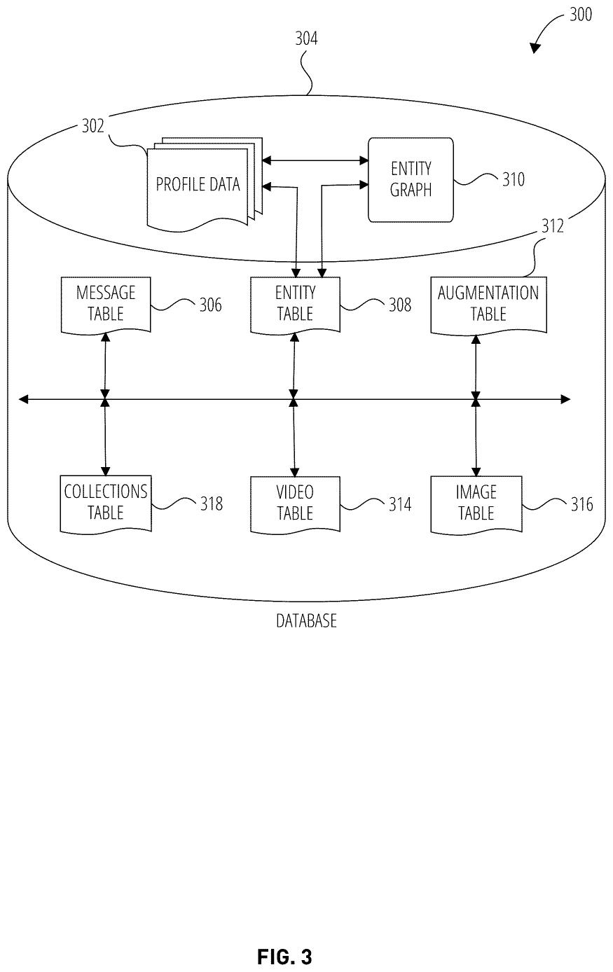

FIG. 3 is a schematic diagram illustrating data structures 300, which may be stored in the database 304 of the interaction server system 110, according to certain examples. While the content of the database 304 is shown to comprise multiple tables, it will be appreciated that the data could be stored in other types of data structures (e.g., as an object-oriented database). In some cases, the database 304 includes features of or corresponds to database 128 in FIG. 1, and/or vice versa.

The database 304 includes message data stored within a message table 306. This message data includes, for any particular message, at least message sender data, message recipient (or receiver) data, and a payload. Further details regarding information that may be included in a message and included within the message data stored in the message table 306, are described below with reference to FIG. 3.

An entity table 308 stores entity data, and is linked (e.g., referentially) to an entity graph 310 and profile data 302. Entities for which records are maintained within the entity table 308 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 310 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100. A friend relationship can be established by mutual agreement between two entities. This mutual agreement may be established by an offer from a first entity to a second entity to establish a friend relationship, and acceptance by the second entity of the offer for establishment of the friend relationship.

Where the entity is a group, the profile data 302 for the group may similarly include one or more avatar representations associated with the group, in addition to the group name, members, and various settings (e.g., notifications) for the relevant group.

The database 304 also stores augmentation data, such as overlays or filters, in an augmentation table 312. The augmentation data is associated with and applied to videos (for which data is stored in a video table 314) and images (for which data is stored in an image table 316).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 316 includes augmented reality content items (e.g., corresponding to applying “lenses” or augmented reality experiences). An augmented reality content item may be a real-time special effect and sound that may be added to an image or a video.

As described above, augmentation data includes augmented reality content items, overlays, image transformations, AR images, and similar terms refer to modifications that may be applied to image data (e.g., videos or images). This includes real-time modifications, which modify an image as it is captured using device sensors (e.g., one or multiple cameras) of the user system 102 and then displayed on a screen of the user system 102 with the modifications. This also includes modifications to stored content, such as video clips in a collection or group that may be modified. For example, in a user system 102 with access to multiple augmented reality content items, a user can use a single video clip with multiple augmented reality content items to see how the different augmented reality content items will modify the stored clip. Similarly, real-time video capture may use modifications to show how video images currently being captured by sensors of a user system 102 would modify the captured data. Such data may simply be displayed on the screen and not stored in memory, or the content captured by the device sensors may be recorded and stored in memory with or without the modifications (or both). In some systems, a preview feature can show how different augmented reality content items will look within different windows in a display at the same time. This can, for example, enable multiple windows with different pseudo random animations to be viewed on a display at the same time.

Data and various systems using augmented reality content items or other such transform systems to modify content using this data can thus involve detection of objects (e.g., faces, hands, bodies, cats, dogs, surfaces, objects, etc.), tracking of such objects as they leave, enter, and move around the field of view in video frames, and the modification or transformation of such objects as they are tracked. In various examples, different methods for achieving such transformations may be used. Some examples may involve generating a three-dimensional mesh model of the object or objects and using transformations and animated textures of the model within the video to achieve the transformation. In some examples, tracking of points on an object may be used to place an image or texture (which may be two-dimensional or three-dimensional) at the tracked position. In still further examples, neural network analysis of video frames may be used to place images, models, or textures in content (e.g., images or frames of video). Augmented reality content items thus refer both to the images, models, and textures used to create transformations in content, as well as to additional modeling and analysis information needed to achieve such transformations with object detection, tracking, and placement.

Real-time video processing can be performed with any kind of video data (e.g., video streams, video files, etc.) saved in a memory of a computerized system of any kind. For example, a user can load video files and save them in a memory of a device or can generate a video stream using sensors of the device. Additionally, any objects can be processed using a computer animation model, such as a human's face and parts of a human body, animals, or non-living things such as chairs, cars, or other objects.

In some examples, when a particular modification is selected along with content to be transformed, elements to be transformed are identified by the computing device, and then detected and tracked if they are present in the frames of the video. The elements of the object are modified according to the request for modification, thus transforming the frames of the video stream. Transformation of frames of a video stream can be performed by different methods for different kinds of transformation. For example, for transformations of frames mostly referring to changing forms of object's elements characteristic points for each element of an object are calculated. Then, a mesh based on the characteristic points is generated for each element of the object. This mesh is used in the following stage of tracking the elements of the object in the video stream. In the process of tracking, the mesh for each element is aligned with a position of each element. Then, additional points are generated on the mesh.

In some examples, transformations changing some areas of an object using its elements can be performed by calculating characteristic points for each element of an object and generating a mesh based on the calculated characteristic points. Points are generated on the mesh, and then various areas based on the points are generated. The elements of the object are then tracked by aligning the area for each element with a position for each of the at least one element, and properties of the areas can be modified based on the request for modification, thus transforming the frames of the video stream. Depending on the specific request for modification properties of the mentioned areas can be transformed in different ways. Such modifications may involve changing the color of areas; removing some part of areas from the frames of the video stream; including new objects into areas that are based on a request for modification; and modifying or distorting the elements of an area or object. In various examples, any combination of such modifications or other similar modifications may be used. For certain models to be animated, some characteristic points can be selected as control points to be used in determining the entire state-space of options for the model animation. In some examples of a computer animation model to transform image data using face detection, the face is detected on an image using a specific face detection algorithm (e.g., Viola-Jones). Then, an Active Shape Model (ASM) algorithm is applied to the face region of an image to detect facial feature reference points.

Other methods and algorithms suitable for face detection can be used. For example, in some examples, features are located using a landmark, which represents a distinguishable point present in most of the images under consideration. For facial landmarks, for example, the location of the left eye pupil may be used. If an initial landmark is not identifiable (e.g., if a person has an eyepatch), secondary landmarks may be used. Such landmark identification procedures may be used for any such objects. In some examples, a set of landmarks forms a shape. Shapes can be represented as vectors using the coordinates of the points in the shape. One shape is aligned to another with a similarity transform (allowing translation, scaling, and rotation) that minimizes the average Euclidean distance between shape points. The mean shape is the mean of the aligned training shapes.

The system can capture an image or video stream on a client device (e.g., the user system 102) and perform complex image manipulations locally on the user system 102 while maintaining a suitable user experience, computation time, and power consumption. The complex image manipulations may include size and shape changes, emotion transfers (e.g., changing a face from a frown to a smile), state transfers (e.g., aging a subject, reducing apparent age, changing gender), style transfers, graphical element application, and any other suitable image or video manipulation implemented by a convolutional neural network that has been configured to execute efficiently on the user system 102.

In some examples, the system operating within the interaction client 104 determines the presence of a face within the image or video stream and provides modification icons associated with a computer animation model to transform image data, or the computer animation model can be present as associated with an interface described herein. The system may implement a complex convolutional neural network on a portion of the image or video stream to generate and apply the selected modification. That is, the user may capture the image or video stream and be presented with a modified result in real-time or near real-time once a modification icon has been selected. Further, the modification may be persistent while the video stream is being captured, and the selected modification icon remains toggled. Machine-taught neural networks may be used to enable such modifications.

### Dynamic Avatar Garment Generation

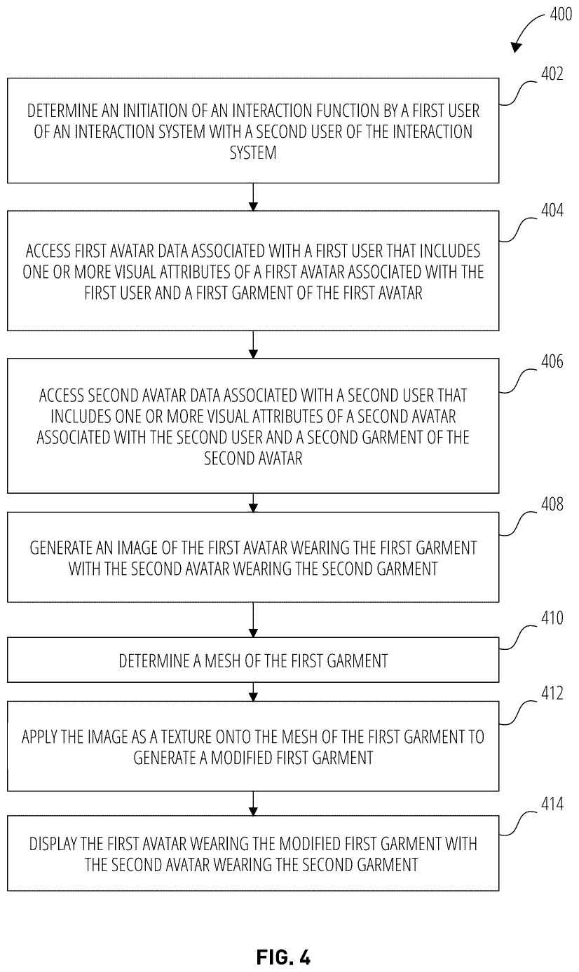

FIG. 4 illustrates an example method 400 for dynamic avatar garment generation, according to some examples. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

FIG. 4, and examples herein are described as being performed by certain systems or applying certain processes, such as a particular machine learning model or computer vision model, but the processes described herein can be performed by one or more other or the same machine learning models, computer vision models, or a combination thereof.

Extended Reality (XR) is an umbrella term encapsulating Augmented Reality (AR), Virtual Reality (VR), Mixed Reality (MR), and everything in between. For the sake of simplicity, examples are described using one type of system, such as XR or AR. However, it is appreciated that other types of systems apply.

Although examples describe a model or the interaction system performing one or more steps herein, it is appreciated that features for the model can be performed by the interaction system and vice versa.

At block 402, the interaction system determines an initiation of an interaction function by a first user of an interaction system with a second user of the interaction system. In some cases, the interaction function triggers one or more of the following processes, such as garment generation for an avatar.

In some cases, the interaction system identifies a trigger or action by the first user within the interaction system that signals the start of an interaction with the second user. An interaction function can include a feature, action, or mechanism provided by the interaction system that allows one user to engage with another.

The system monitors and detects specific actions taken by the first user. This initiation can be explicit (e.g., clicking a button to “customize t-shirt”) or implicit (e.g., navigating to the second user's profile or entering proximity). The initiation may be determined using event-based signals such as user input (e.g., a click, tap, gesture, or voice command), system logs (e.g., detecting an action such as opening a chat, a profile, or selecting a particular feature), proximity or presence (e.g., recognizing that two users are close together in a virtual environment or real-world setting using geolocation data), and/or the like as further described herein.

In some examples, determining an initiation of an interaction function includes detecting user interaction with a camera feed displayed on the user system 102, where the first user performs an action that triggers engagement with a second user. Such actions may include selecting a real-world object on a camera feed or selecting a digital item or overlay shown on the camera feed.

In some examples, determining the initiation of an interaction function includes identifying actions performed in a chat window where messages, stickers, emojis, and other media content items are shared between the first user and the second user via user systems 102.

Examples of initiation actions can include sending photos or videos to the second user or a group that includes the second user, where the content may be edited with text, stickers, filters, and drawings before being sent. Additional actions can include capturing a video or audio message, inputting text, or other communications that disappear after being viewed or upon meeting specific conditions, such as a time limit.

In some examples, determining initiation of an interaction function can include identifying the generation or viewing of collections of videos, messages, stickers, or other media content items shared between the first and second users, which may include shared ephemeral content visible for a predetermined period of time (e.g., 24 hours).

Initiation of an interaction function may include detecting engagement with media content items displayed from other users, such as publishers, creators, or influencers, where the first user explores and interacts with content that may relate to or reference the second user.

In other examples, determining initiation of an interaction function involves monitoring interactions with map and location functions, such as the first user sharing their location with the second user, viewing the second user's location on a map, or exploring a map containing points of interest related to shared activities or events.

Determining initiation of an interaction function can include actions related to avatars, such as personalizing, applying, or viewing avatars, where the first user initiates avatar-based activities involving the second user.

Detection of initiation of an interaction function can include user input events such as clicks, taps, or gestures performed on interactive elements related to the second user, navigating to or selecting the second user's profile, content, or avatar, actions in group contexts where the first user engages with content involving the second user (e.g., group chats, multiplayer games, or shared media archives), and/or the like.

In some examples, determining initiation of an interaction function includes capturing actions in Augmented Reality (AR), such as detecting AR-based interactions where the first user focuses on content, objects, avatars, or virtual garments related to the second user.

In some examples, determining the initiation of an interaction function includes identifying proximity-based triggers, where the first user and second user are detected in the same virtual or real-world location using location data, such as GPS.

FIG. 5 illustrates a “best friends” interaction function, according to some examples. In FIG. 5, the interaction function begins when the first user initiates an interaction by navigating into the “best friends” user interface 502 of the interaction system. This interface is specifically designed to display both the first user's avatar 504 and a second avatar 506 of their designated best friend in a shared view.

At this stage, the system detects that the user has triggered the interaction function by accessing this interface, which serves as the initiation point for subsequent processes. Upon entering the best friends interface, the system performs other functions, such as retrieving and displaying the avatar data of both users. The first avatar corresponds to the first user, and the second avatar corresponds to their best friend.

The avatars are shown with their respective visual attributes, such as facial features, poses, and garments, as they exist in their default or current states. At this point, the garment of the first avatar has not yet been modified to include the combined avatar design or any additional features. Instead, the user interface presents the avatars in a preliminary state, providing the user with an opportunity to engage further, such as by selecting or customizing the virtual garment.

In some cases, accessing a particular user interface, such as a “best friends” user interface automatically triggers the modification of a garment (as further described herein). In other cases, the interaction function within the “best friends” user interface can include a button 508 or selectable element that serves as a trigger to initiate the garment modification process. When the first user presses this button, the system begins generating the modified garment (as further described herein).

At block 404, the interaction system accesses first avatar data associated with a first user that includes one or more visual attributes of a first avatar associated with the first user and a first garment of the first avatar. The interaction system retrieves specific information stored within the system that defines the appearance and characteristics of the first user's avatar, as well as details about the first avatar's garment.

The system first identifies the first user initiating the interaction, such as through their account credentials, user ID, or interaction trigger (e.g., accessing the “best friends” interface or pressing a specific button). This identification links the user to their corresponding avatar data stored within the system.

The system accesses first avatar data, which includes information about the visual attributes of the first avatar. These visual attributes can include facial features (e.g., shape of the face, eyes, nose, mouth, and other facial characteristics), pose and expression (e.g., static or dynamic body positions and emotional expressions such as smiling, winking, or neutral states), customizations (e.g., user-selected preferences like hairstyles, eye color, skin tone, and accessories (glasses, hats, etc.), and/or the like.

The avatar data can include a first garment associated with the first avatar. A garment can be any virtual clothing item, such as a t-shirt, hoodie, jacket, or other accessories. The first garment includes specific attributes that define its design and structure. These attributes may include a type of garment such as a category of clothing (e.g., short-sleeve t-shirt, long-sleeve sweater, or pants), color and texture (e.g., visual characteristics like fabric color, patterns, and surface textures), mesh or geometry (e.g., underlying 3D mesh data that defines the shape and structure of the garment on the avatar), fit and positioning (e.g., how the garment conforms to the avatar's body, ensuring alignment with its shape and proportions), and/or the like.

In some cases, the avatar data, including visual attributes and garment details, is stored in a user profile database or avatar customization system. The system may access profile-related data associated with the first user (e.g., to gather or to supplement the first avatar data). This profile data can include user-specific details relevant to the customization or display of the avatar and its associated garments.

For example, profile data can include connections and relationships with other users, such as the first user's list of friends, followers, or other connections. This relationship data may be used to identify a designated “best friend” whose avatar will be incorporated into the garment customization process.

In some cases, profile data may include user preferences and customizations, such as previously selected themes, interests, or favorite styles. These preferences can inform the visual appearance of the first avatar's garment, such as color schemes, patterns, or decorative elements.

The system may also access historical interaction data, such as shared activities, messages, or content between the first user and the second user. This data can help establish a relationship context that is reflected in the avatar garment design.

Additionally, profile data may include location-based information, such as a user's city or recent GPS coordinates. For example, the system could incorporate location-specific visual elements into the garment to reflect a shared place or event relevant to the avatars being displayed.

In some implementations, the system may use device-related profile data, such as device type or operating system, to optimize how the avatar and garment are rendered on the user's platform, ensuring proper visual alignment and performance.

By accessing and integrating relevant profile data, the system can enhance the visual attributes and contextual relevance of the first avatar and its garment, providing a richer and more personalized avatar experience.

At block 406, the interaction system accesses second avatar data associated with a second user that includes one or more visual attributes of a second avatar associated with the second user and a second garment of the second avatar. The interaction system retrieves and prepares the second avatar's details.

Before accessing the second avatar data, the system determines the identity of the second user. This determination can occur based on various triggers, such as an explicit selection (e.g., the first user explicitly selects or interacts with the second user's profile, such as clicking a “best friend” option or interacting with a friend's avatar within a “best friends” user interface), predefined relationships (e.g., the system uses stored relational data (e.g., friends list, “best friend” designation, or group associations) to identify the second user as relevant to the ongoing interaction), contextual triggers (e.g., context from prior activities, such as both users being in the same location, participating in shared activities, or engaging with each other's content, may determine the second user), and/or the like. Once the second user is identified, the system links their account to the corresponding avatar data stored in a database or avatar repository.

In some cases, the second user may be identified based on specific relationship types or milestones. For example, the interaction system can identify a best friend relationship where the second user is the designated “best friend” of the first user. Such a designation can be manually set or determined by actions such as frequent interactions, shared activities, or user-defined tags. In some cases, the relationship can include team members where the second user may be part of a group or team associated with the first user, such as teammates on a basketball team, club members, or other collaborative groups. In some cases, the relationship can include celebrities or influencers where the second user may be a prominent figure (e.g., celebrity avatar or content creator) whom the first user follows or interacts with, allowing the system to generate content featuring that relationship.

In some cases, the relationship can include gamification connections where the second user may be identified through a gamified interaction, such as achieving a shared milestone, earning points together in multiplayer games, or completing challenges that involve the two users. In some cases, the relationship can include milestone recognition where the system may identify the second user based on significant shared events or milestones, such as a first trip taken together, an anniversary of a friendship, or other contextually important activities.

These identification mechanisms ensure that the second user is not only relevant to the interaction but also aligns with the context and purpose of the avatar data retrieval. By incorporating specific relationships like best friends, teammates, and shared milestones, the system provides a more personalized and meaningful experience for the first user.

In some cases, this feature can be configured to unlock exclusively for certain relationships, such as “best friends,” adding a layer of personalization and exclusivity to the experience. The interaction system identifies the relationship type based on user data, such as friend lists, interaction frequency, or explicit designations made by the users (e.g., marking someone as a “best friend”). Once the relationship meets the predefined criteria, the feature allows the creation and display of customized content, such as the first avatar wearing the modified first garment and the second avatar wearing the second garment.

The interaction system retrieves the second avatar data, which can include visual and customization details necessary to generate or display the second avatar. The retrieved data can include visual attributes of the second avatar. These attributes can define the appearance of the second user's avatar as further described for the first avatar data. The second avatar data can include second garment data (similar to the first garment data in the first avatar data).

At block 408, the interaction system generates an image of the first avatar wearing the first garment with the second avatar wearing the second garment. The interaction system can combine the visual representations of both avatars in a single frame.

To generate the image, the interaction system can utilize inputs gathered from earlier steps such as the first avatar data which includes visual attributes of the first avatar (e.g., facial features, pose, expressions, customizations) and details of the first garment (e.g., type, color, patterns, mesh data), and second avatar data that can include visual attributes of the second avatar and details of the second garment.

Each avatar can be rendered based on its respective visual attributes, such as facial features, body and pose, customization elements, and/or the like. The interaction system also renders and applies garments for both avatars, such as the first garment and the second garment, where the first garment is applied to the portion of the image of the first avatar and the second garment is applied to the portion of the image of the second avatar.

The system ensures the avatars are positioned correctly in relation to each other. For example, the interaction system can apply scaling where both avatars are scaled proportionally to avoid size mismatches, and/or spatial arrangement where avatars are placed in a layout that emphasizes their relationship, such as standing next to each other, facing each other, or interacting.

In some cases, the system adds background elements to the image such as a neutral Background (e.g., a plain background may be used to highlight the avatars and their garments), contextual scenes such as backgrounds can include elements reflecting the interaction context, such as shared locations, group settings, or themed designs (e.g., birthday decorations, sports environments), dynamic effects such as lighting or animations, may be added to enhance the image's aesthetic, and/or the like.

The system generates a single image file or visual representation, which can be used in various ways, such as on a display in the user interface, sharing to others, or as input for subsequent features (as further described herein).

At block 410, the interaction system determines a mesh of the first garment. The interaction system identifies and retrieves the structural framework that defines the shape, fit, and geometry of the garment on the first avatar. The mesh can include a collection of vertices, edges, and faces that form the geometric representation of a 3D object—in this case, the first garment. The mesh determines how the garment conforms to the avatar's body and interacts with other elements in the scene.

Vertices can include points in 3D space that define the shape and structure of the garment. edges can include lines connecting vertices that outline the garment's shape. faces can include flat surfaces formed by connecting edges, creating the visible surface of the garment. topology can include the arrangement and connectivity of vertices, edges, and faces, which influences the garment's flexibility and appearance.

In some cases, the interaction system determines the mesh of the first garment via predefined mesh retrieval, where the first garment already has a predefined mesh stored in a database or customization system. The system retrieves this existing mesh, which was created during the garment's design or customization phase with the avatar, where the mesh is aligned with the first avatar's body proportions to ensure proper fit.

In some cases, the interaction system dynamically generates the mesh based on the first avatar's current pose, size, or body proportions. The system applies algorithms to calculate a mesh that conforms to the avatar's body, adjusting for factors such as: movement or pose changes, or custom body proportions or unique avatar features. If the garment has been customized (e.g., resized, stretched, or decorated), the mesh is recalculated to reflect these changes.

The mesh must fit seamlessly onto the first avatar, requiring the system to consider body proportions (e.g., the avatar's height, width, and shape are used to adjust the mesh dimensions), pose alignment (e.g., the mesh is adapted to the avatar's current pose or animation, such as arms raised or a seated position), skin and collision detection (e.g., ensuring the mesh does not intersect with the avatar's body (e.g., the garment “clips” through the avatar) or overlap inappropriately with other garments or accessories), and/or the like.

At block 412, the interaction system applies the image as a texture onto the mesh of the first garment to generate a modified first garment. The interaction system overlays the combined visual representation of the first avatar and the second avatar onto the structural framework (mesh) of the first garment, resulting in a personalized and visually modified garment.

To apply the texture, the system can use the Mesh of the first garment, the image that combines the visual attributes of the first avatar and the second avatar, serves as the texture to be applied to the mesh, and/or a predefined or dynamically generated UV map of the garment, which unrolls the 3D mesh into a flat 2D plane to define how the texture will wrap around the garment.

The interaction system aligns the image with the UV map of the first garment. The UV map defines which parts of the image correspond to specific regions of the garment, ensuring that the avatars'visual representation (e.g., faces, poses) appears on the correct sections of the garment. The system ensures the texture is scaled, rotated, or translated as needed to fit the garment's proportions and design.

The 2D image is “wrapped” onto the 3D garment mesh by projecting the image along the mesh's surface so that it follows the garment's contours and geometry. The system accounts for any stretching, distortion, or alignment issues to ensure the image appears seamless on the garment.

Once the image is successfully applied, the system generates the modified first garment, which now visually incorporates the combined avatars. The modified garment features the combined image of the first and second avatars, creating a unique, user-specific design. The applied texture seamlessly integrates with the garment's mesh and aligns with the first avatar's body proportions.

At block 414, the interaction system displays the first avatar wearing the modified first garment with the second avatar wearing the second garment. The interaction system renders the visual representation of the first and second avatars together, where the first avatar now incorporates the personalized design on its garment, and the second avatar retains its original appearance. The system combines the visual attributes of the first and second avatars into a single scene or interface where the first avatar is rendered with its updated attributes, such as the modified first garment.

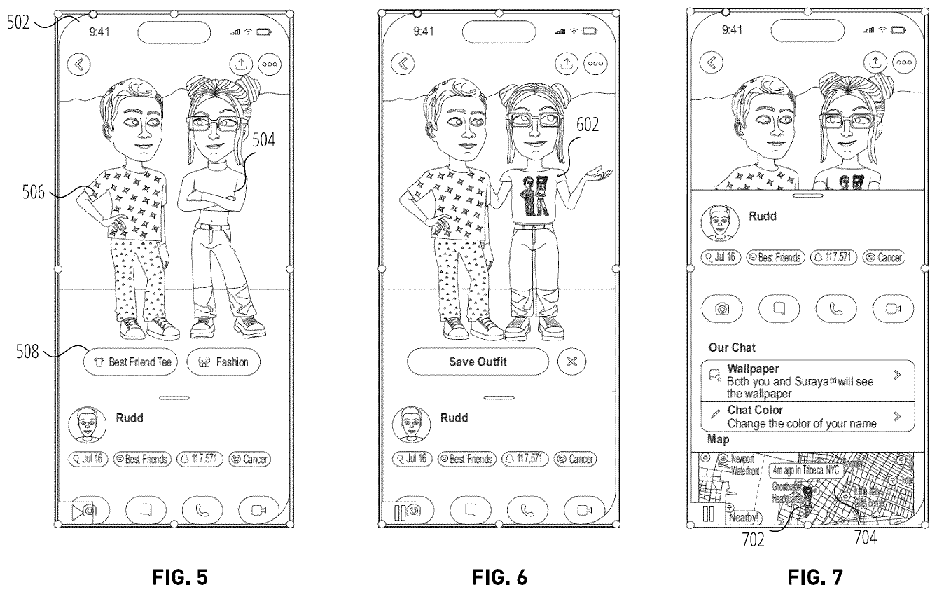

FIG. 6 illustrates the first avatar wearing the modified garment a “best friends” t-shirt, according to some examples. The t-shirt 602 prominently features a customized image that combines the visual representations of both the first and second users. This design symbolizes the relationship between the two users and showcases their connection in a personalized and visually engaging way.

The t-shirt, as shown in FIG. 6, is a virtual garment with the combined image of the two avatars applied as a texture. The first avatar is depicted wearing the t-shirt, with the image of both avatars displayed on the front in a way that highlights their unique attributes, such as facial features, poses, and expressions. The integration of the two avatars'visuals into the garment is seamless, with the image aligned and scaled to fit the garment's contours. The design may also include additional aesthetic elements, such as names, usernames, or thematic decorations, further enhancing the personalization.

The joint avatar image, featuring the visual representations of the first and second users, can be applied to other parts of the avatar beyond the t-shirt, such as a hat, shoes, or pants. By expanding the customization options, the system can create a broader range of personalized virtual garments that allow users to celebrate their relationships in diverse and creative ways.

For example, a hat could display a scaled-down version of the joint avatar image as a logo or patch on the front or side. Alternatively, the image could be wrapped around the hat's band or brim, ensuring it is prominently visible while conforming to the hat's unique shape and surface. Shoes provide another opportunity for customization; the joint avatar image could be applied to the sides, soles, or tongues of the shoes, with adjustments made to the design to fit these smaller, irregularly shaped surfaces. For pants, the image could be positioned on a specific area, such as a leg panel or pocket, or spread across both legs in a mirrored or repeated pattern, making the design eye-catching yet contextually appropriate.

To ensure these applications are visually appealing and seamless, the system can dynamically adapt the image's size, orientation, and layout based on the garment type and its mesh. The interaction system can align the image with the contours and dimensions of the garment, preventing distortion or misalignment. Additionally, the system could offer customization options to the user, such as choosing which part of the outfit features the joint avatar image or incorporating complementary design elements, such as colors, patterns, or text, to enhance the overall aesthetic.

In some examples, the interaction system can modify garments with the user's avatar with the avatar of other users that are associated with the user (such as within an interaction function of the interactive system) which can include followers or friends, where users can follow or be followed by others, or form some form of relationship such that other users can see certain information, such as each other's posts on their feeds. In some examples, the other users can include “close” or “best” friends that can create a relationship to share additional information not available to others, such as private posts, targeted sharing of content, and/or the like.

In some examples, other users are users mentioned or tagged in the user's posts, comments, chat messages, or other communication that draws the attention of the tagged user and/or can initiate conversations or discussions. In some examples, other users are users that are involved in a message chat with the user, such as a private messaging feature that allows users to send messages directly to one another or group chats among many users. In some examples, other users are users that joined a group based on shared interests or common goals. Within these groups, users can interact and form relationships based on the group's focus and/or share information among group members. In some examples, other users are users who express support for users, such as through likes, comments, or shares, or vice versa. In some examples, other users are influencers or brand ambassadors that have established large followings and are seen as authorities or trendsetters in their niches. In some examples, other users are collaborators working together on projects or create content together.

In some cases, the interaction system modifies garments based on group chats to promote personalized Bitmojis or custom garments, such as t-shirts, which offers a unique opportunity to enhance user engagement and foster a sense of community within the interaction system. The interaction system extends the personalization and customization features currently applied to pairs of users (e.g., “best friends”) to entire groups, such as group chats focused on shared activities, interests, or themes.

Custom garments, such as t-shirts, can be tailored to represent the entire group. These garments may feature a group of avatars with a design that includes all members'avatars displayed together in a unified composition, such as a collage or a thematic arrangement that reflects the nature of the group (e.g., brunch squad, study group, or gaming clan).

In some cases, each garment can display the names or usernames of all group members, either individually listed or integrated into the design, creating a personal and memorable keepsake. The design can incorporate elements unique to the group, such as shared jokes, favorite activities, or significant milestones (e.g., a trip, an event, or reaching a group goal). For example, a “brunch group chat” can result in t-shirts displaying avatars of all participants enjoying a themed setting, such as sitting around a table with food and drinks. The design could be further personalized with the group's inside jokes or hashtags.

The interaction system can provide group chat members with the ability to collaboratively create and share custom garments. A group admin or any member could initiate the process by selecting the group chat and launching a garment customization feature within the platform. Group members can contribute to the design, such as choosing avatar poses, selecting colors, or adding text (e.g., hashtags or slogans). Once created, the custom garment can be displayed within the chat for all members to see and share. Members could also unlock the design to apply to their own avatars or purchase physical versions.

A machine learning model can analyze characteristics of the group chat, such as context, shared messages, and/or profile information, to dynamically tailor the modification of garments. By processing text data (e.g., messages about brunch plans) and metadata (e.g., time, location, and participants), the model can infer key details about the event, such as the activity (“eating brunch”), time (“Saturday morning at 12 PM”), and location (“Marcy's restaurant”).

Using this contextual understanding, the model can generate contextual information and/or a personalized garment design featuring the avatars of the group members in a brunch setting, incorporating visual elements like food, beverages, and a restaurant logo. The model can further enhance the design with text overlays, such as “Saturday Brunch 12 PM at Marcy's,” creating a garment that serves both as a reminder and a visual representation of the planned activity. This automation enhances user engagement by seamlessly integrating personalized and context-aware designs into the group's interaction.

The interaction system can apply an ML model in automatically determining or generating designs of the avatars to apply for generating modified garments by leveraging diverse data sources to extract patterns, preferences, and contextual relevance. The model accesses one or more data points to understand the context and personalize the garment design.

The model can analyze past user preferences, such as liked items, saved designs, or purchased virtual/physical products. For instance, if a user has purchased or favored garments with sports logos, the model may include sporty themes in the design.

The interaction system can access data about hobbies (e.g., hiking, gaming, or cooking) that can help tailor designs that resonate with the user's lifestyle. For example, a gamer's avatar might include joystick motifs, while a foodie's could incorporate restaurant imagery.

The model can continuously adapt based on recent activities. For example, if users in a group chat have been discussing a new movie, the garment may feature imagery related to that film. In some cases, the model identifies event context such as seasonal events, birthdays, or shared plans (e.g., attending a concert) provide a foundation for theme-based designs.

The interaction system can access data about commonalities in users'profile data and can suggest harmonized designs, such as matching color schemes or complementary patterns for all avatars in a group. The interaction system can access sentiment analysis of recent interactions can guide the tone of the design. For example, cheerful conversations might inspire bright, playful motifs, while nostalgic discussions might result in subdued, classic patterns.

The model identifies key elements from user data (e.g., hobbies, interests, event context) and determines how they can be visually represented. For instance for brunch plans, the model may choose food-related graphics or avatars seated around a table. For a group hiking trip, the model may add mountains, backpacks, or hiking trails to the design.

The model uses generative algorithms to combine extracted elements into cohesive designs. Techniques such as generative adversarial networks (GANs) or diffusion models may be employed to create visually appealing layouts that balance personalization and group coherence.

The model ensures consistency in design elements across avatars in the group, such as matching color schemes based on seasonal or event-based palettes, coordinating garment details, such as applying the same logo or pattern in complementary placements (e.g., on sleeves or hats), and/or the like.

For seasonal events, the model may include holiday motifs (e.g., snowflakes for winter) or cultural celebrations (e.g., fireworks for New Year). For birthdays, the model may incorporate festive graphics, such as balloons or cakes, into the design. For a planned morning event, the design might feature sunny motifs or breakfast themes. Sentiment analysis of chat conversations could inspire mood-based adjustments, such as adding cheerful or reflective design elements.

The ML model can also enable collaborative customization. Users may be given initial suggestions based on the model's output and allowed to make adjustments, which the model learns from for future recommendations.

In some cases, the interaction system incorporates a feature allowing users to access customized garments, such as t-shirts, hoodies, or matching outfits, based on their proximity to other users as displayed on a map interface. This capability leverages geolocation tracking and distance proximity data to dynamically generate or unlock garments that reflect the relationship or activity of nearby users.

The system continuously tracks the geographic locations of users via GPS or other geolocation technologies embedded in their devices. Users'locations are mapped in real time and displayed on the map interface, showing their relative positions to one another.

The system calculates the distance between two or more users on the map. This distance threshold can be predefined (e.g., within 50 meters) or dynamically adjusted based on the type of interaction or garment.

The system tracks how long users remain within the proximity threshold. If users are near each other for an extended period, the system may prioritize generating or unlocking specific garment designs tailored to their interaction. For example, two friends meet at a coffee shop and appear on the map within close proximity. The system detects this and unlocks matching t-shirts featuring their avatars and the name of the coffee shop, or a design that reflects their shared activity after the users are in close proximity (e.g., within the same store, within 5 meters) for a certain period of time.

If two users are actively using the map feature at the same time, the system can detect this simultaneous activity. The system may display a special icon or notification on the map interface, indicating the potential for garment customization or access. Users can tap on the icon to generate or unlock garments that reflect their current map interaction. For example, a shared t-shirt design might include their avatars waving at each other with a timestamp of their meeting.

Users can choose from a range of proximity-based garments, such as A hoodie displaying both avatars and a message like “Met at Central Park” or matching t-shirts celebrating their location, event, or shared activity. The system can incorporate real-time data, such as location names, dates, and group details, into the garment design.

At events like concerts or sports games, users in proximity can unlock themed garments, such as a concert t-shirt featuring their avatars and the event logo. When multiple users are detected in proximity, the system can generate group designs with all participants'avatars included.

The interaction system identifies a first location of the first user by accessing GPS coordinates from a first computing device, such as a smartphone or wearable device. Similarly, the system identifies a second location of the second user based on GPS coordinates obtained from a second computing device. These GPS coordinates provide precise geographic positions for both users and are used to determine their relative proximity. The system ensures that the coordinates are up-to-date by continuously or periodically polling location data from the devices.

Once the locations are identified, the system calculates the distance between the first and second locations. This calculation is compared to a predefined distance threshold, such as 50 meters or a user-configurable range. If the system determines that the distance between the two locations is within the threshold, it triggers the display of the first avatar wearing the modified first garment alongside the second avatar wearing the second garment. By tying the display of the avatars and garments to proximity data, the system creates a dynamic and context-aware user experience that enhances personalization and interaction, such as showcasing garments in real time when users meet or are nearby.

The interaction system identifies a first location of the first user by accessing GPS coordinates from a first computing device, such as a smartphone. This geographic data pinpoints the user's current position in real-time or near-real-time. Simultaneously, the system references a second location corresponding to a merchant, such as a pizza restaurant or coffee shop, using stored or dynamically retrieved GPS coordinates associated with that merchant. The system then determines whether the first location is within a predefined distance threshold of the merchant's location, such as 100 meters or another configurable range.

FIG. 7 illustrates a user interface whereby GPS data is used to generate the modified garment, according to some examples. The user interface shows that the first user 702 is within a certain distance from a pizza store 704, and as such, the interaction system can apply an image displaying the first user's avatar and the second user's avatar eating pizza on a t-shirt.

If the system determines that the first user is within the specified proximity to the merchant, it incorporates the merchant's goods or services into the generated image featuring the first and second avatars. For example, if the merchant is a pizza restaurant, the system may display the avatars eating pizza or sitting at a table with pizza and drinks in the scene. This contextual integration of the merchant's offerings into the image creates a dynamic and personalized representation, reinforcing the connection between the users'activities and their environment. This approach enhances the user experience by linking real-world locations to virtual customization and interaction, potentially supporting additional features like promotional content or location-based recommendations.

The interaction system can enhance the personalization of the modified garment by incorporating contextual elements tied to a past activity shared between the first and second users. The system identifies these activities by analyzing historical data, such as location check-ins, shared photos, conversations, or participation in events logged within the platform. For instance, if the first and second users attended a concert together or went on a hiking trip, the system retrieves these details and uses them as the basis for the contextual elements added to the garment design.

The contextual elements could include imagery, symbols, or text representing the shared activity, such as a concert poster, a scenic mountain graphic, or the name of a location visited together (e.g., “New York Trip 2023”). These elements act as a time capsule, visually capturing and preserving the memory of the event. This feature not only personalizes the garment further but also strengthens the emotional connection between the users by reflecting their shared experiences.

The system enables the seamless transition from virtual customization to real-world product creation by transmitting data corresponding to the image of the first avatar wearing the first garment with the second avatar wearing the second garment to a third-party server. This data includes design elements, such as the graphical representation of the avatars, the modified garment design, and relevant metadata, including size, color, and placement details. Upon receiving this data, the third-party server initiates the manufacturing process, translating the virtual garment into a physical product tailored for the first user.

This functionality bridges the gap between digital and physical experiences, allowing users to own real-life versions of their personalized designs. For instance, the transmitted data ensures that the avatars, graphics, and contextual elements (e.g., shared memories or event-specific themes) are reproduced on the physical garment. By leveraging this integration, the system not only enhances the user's connection to their digital interactions but also unlocks new opportunities for monetization, such as facilitating partnerships with manufacturers and enabling users to purchase unique, sentimental items tied to their virtual experiences.

Systems and methods described herein include training a machine learning model to identify and determine contextual information within interactions between users. The machine learning model can be trained to recognize topics of discussion in various contexts, such as messages exchanged in a chat window, posts or comments shared between users, interactions in group chats, or activities performed in third-party applications, such as collaborative games. The training process leverages historical interaction data, which includes prior messages, activities, or shared content between users, alongside labeled context or topics, to create a robust understanding of user communication patterns.

Training machine learning models in this context is rooted in advancements in computer technology and improves the system's ability to process and infer relevant contextual information from interaction data. These models are trained using complex algorithms and large datasets to adjust their parameters, such as weights or scores, through methods like logistic regression or forward/backward propagation. Once trained, the models can be applied to new inputs, such as real-time user interactions, including current messages between a first user and a second user. For example, the trained model can analyze a chat window to infer a discussion topic, such as planning a trip or a shared event.

The training process typically involves high computational demands and large-scale server systems capable of processing vast datasets. By iteratively adjusting parameters based on input data and expected outputs, the machine learning models are refined to reduce false positives and improve accuracy in identifying contextual information. This enables the system to personalize outputs, such as generating relevant garment designs or avatars, based on real-time interaction data. Such training not only enhances the system's capability to dynamically respond to new data but also ensures precise and meaningful customization for user interactions.

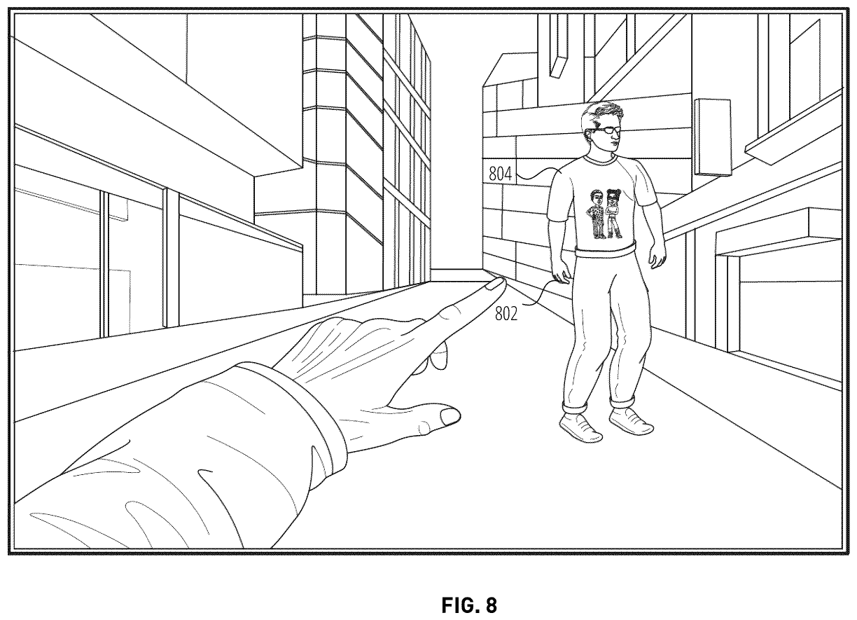

FIG. 8 illustrates a content augmentation displaying the modified t-shirt on a live camera feed, according to some examples. In some cases, the interaction system allows for the display of the first avatar wearing the modified first garment with the second avatar wearing the second garment by integrating the modified image directly into a live camera feed. When the user activates the live camera feed, the system applies a content augmentation by superimposing the combined avatars and their customized garments onto the live feed captured by the user's device camera. This augmentation merges virtual content with real-world imagery, creating an immersive experience.

For example, as the user points their camera at a physical space, the interaction system identifies a user 802 in the live camera feed, identifies the user's garment (e.g., real world t-shirt), overlays the avatars with the modified garments via a content augmentation 804, and displays the user in the live camera feed wearing the t-shirt with the modified image.

The content augmentation capabilities of the system leverage augmented reality (AR) to enhance the interactivity and personalization of the modified garments. One example is the ability to click on the shirt displayed on the avatar through an AR interface, which triggers the display of interactions between the friends represented on the garment. For instance, clicking on a t-shirt featuring two avatars could reveal a video montage of shared activities, such as a recent trip or significant milestones, providing an engaging and sentimental experience for the user.

Additionally, the system supports hidden messages and emojis that become visible only when viewed through specific AR lenses. For example, a t-shirt may contain a concealed graphic or an animated emoji that appears when the user activates a compatible lens in the interaction system. This feature adds an element of surprise and exclusivity, creating a playful and dynamic user experience. Such hidden elements can also include personalized notes or shared jokes between friends, further enhancing the garment's emotional significance.

The system also enables the creation of a t-shirt when users scan a physical garment or another friend's avatar using their device's camera. This functionality bridges the digital and physical worlds, allowing users to generate customized virtual garments by simply interacting with real-world objects or avatars. For example, scanning a friend's hoodie could unlock a matching virtual t-shirt featuring both users'avatars and shared memories.

Furthermore, the system provides flexibility in AR interactions by allowing users to switch the displayed avatars on a garment. For instance, if the user sees an outfit featuring themselves and one best friend, they can dynamically replace the second avatar with another close friend through the AR interface. This feature ensures that users can effortlessly adapt the design to reflect different relationships, making the garments versatile and meaningful across multiple connections. These AR-powered enhancements elevate the utility of the system, making it a highly engaging platform for creating, sharing, and interacting with personalized garments.

### Data Communications Architecture

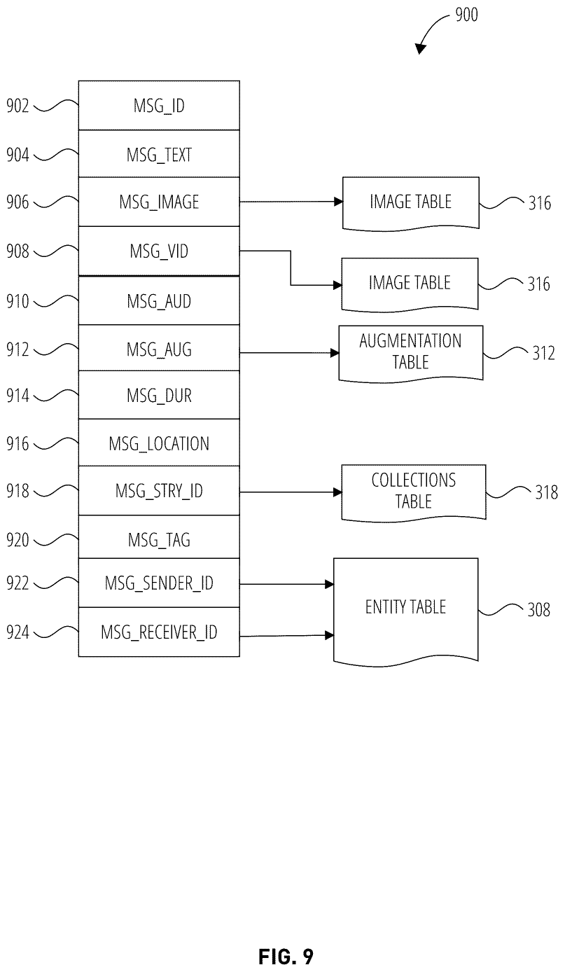

FIG. 9 is a schematic diagram illustrating a structure of a message 900, according to some examples, generated by an interaction client 104 for communication to a further interaction client 104 via the interaction servers 124. The content of a particular message is used to populate the message table 306 stored within the database 304, accessible by the interaction servers 124. Similarly, the content of a message 900 is stored in memory as “in-transit” or “in-flight” data of the user system 102 or the interaction servers 124. A message 900 is shown to include the following example components:
Message identifier 902: a unique identifier that identifies the message 900.
Message text payload 904: text, to be generated by a user via a user interface of the user system 102, and that is included in the message 900.
Message image payload 906: image data, captured by a camera component of a user

system 102 or retrieved from a memory component of a user system 102, and that is included in the message 900. Image data for a sent or received message 900 may be stored in the image table 316.
Message video payload 908: video data, captured by a camera component or retrieved from a memory component of the user system 102, and that is included in the message 900. Video data for a sent or received message 900 may be stored in the image table 316.
Message audio payload 910: audio data, captured by a microphone or retrieved from

a memory component of the user system 102, and that is included in the message 900.
Message augmentation data 912: augmentation data (e.g., filters, stickers, or other

annotations or enhancements) that represents augmentations to be applied to message image payload 906, message video payload 908, or message audio payload 910 of the message 900. Augmentation data for a sent or received message 900 may be stored in the augmentation table 312.
Message duration parameter 914: parameter value indicating, in seconds, the amount of time for which content of the message (e.g., the message image payload 906, message video payload 908, message audio payload 910) is to be presented or made accessible to a user via the interaction client 104.
Message geolocation parameter 916: geolocation data (e.g., latitudinal and longitudinal coordinates) associated with the content payload of the message. Multiple message geolocation parameter 916 values may be included in the payload, each of these parameter values being associated with respect to content items included in the content (e.g., a specific image within the message image payload 906, or a specific video in the message video payload 908).
Message story identifier 918: identifier values identifying one or more content collections (e.g., “stories” identified in the collections table 318) with which a particular content item in the message image payload 906 of the message 900 is associated. For example, multiple images within the message image payload 906 may each be associated with multiple content collections using identifier values.
Message tag 920: each message 900 may be tagged with multiple tags, each of which

is indicative of the subject matter of content included in the message payload. For example, where a particular image included in the message image payload 906 depicts an animal (e.g., a lion), a tag value may be included within the message tag 920 that is indicative of the relevant animal. Tag values may be generated manually, based on user input, or may be automatically generated using, for example, image recognition.
Message sender identifier 922: an identifier (e.g., a messaging system identifier,

email address, or device identifier) indicative of a user of the user system 102 on which the message 900 was generated and from which the message 900 was sent.
Message receiver identifier 924: an identifier (e.g., a messaging system identifier,

email address, or device identifier) indicative of a user of the user system 102 to which the message 900 is addressed.

The contents (e.g., values) of the various components of message 900 may be pointers to locations in tables within which content data values are stored. For example, an image value in the message image payload 906 may be a pointer to (or address of) a location within an image table 316. Similarly, values within the message video payload 908 may point to data stored within an image or video table 316, values stored within the message augmentation data 912 may point to data stored in an augmentation table 312, values stored within the message story identifier 918 may point to data stored in a collections table 318, and values stored within the message sender identifier 922 and the message receiver identifier 924 may point to user records stored within an entity table 308.

### System With Head-Wearable Apparatus

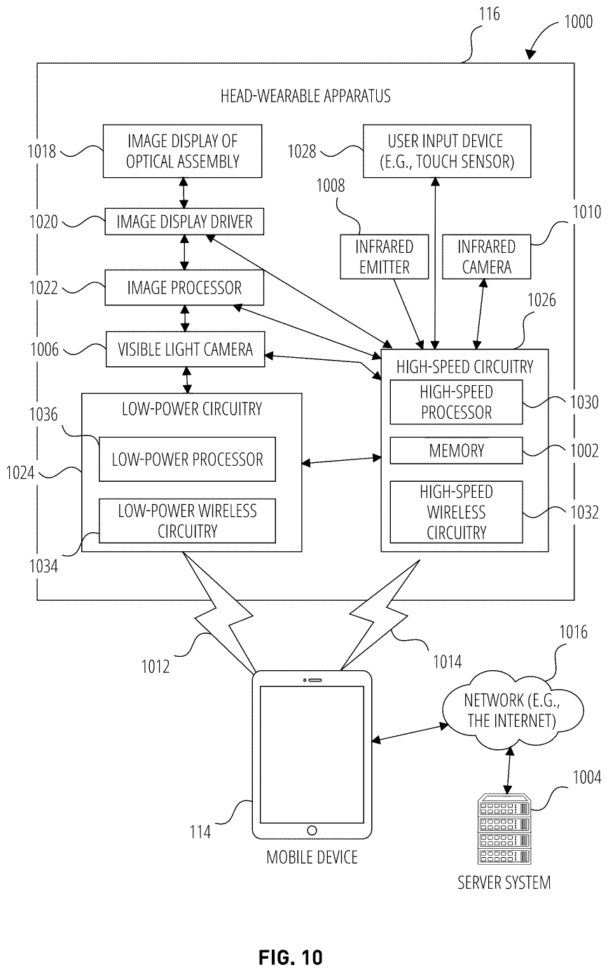

FIG. 10 illustrates a system 1000 including a head-wearable apparatus 116 with a selector input device, according to some examples. FIG. 10 is a high-level functional block diagram of an example head-wearable apparatus 116 communicatively coupled to a mobile device 114 and various server systems 1004 (e.g., the interaction server system 110) via various networks 108. The networks 108 may include any combination of wired and wireless connections.

The head-wearable apparatus 116 includes one or more cameras, each of which may be, for example, a visible light camera 1006, an infrared emitter 1008, and an infrared camera 1010.

An interaction client, such as a mobile device 114 connects with head-wearable apparatus 116 using both a low-power wireless connection 1012 and a high-speed wireless connection 1014. The mobile device 114 is also connected to the server system 1004 and the network 1016.

The head-wearable apparatus 116 further includes two image displays of the image display of optical assembly 1018. The two image displays of optical assembly 1018 include one associated with the left lateral side and one associated with the right lateral side of the head-wearable apparatus 116. The head-wearable apparatus 116 also includes an image display driver 1020, an image processor 1022, low-power circuitry 1024, and high-speed circuitry 1026. The image display of optical assembly 1018 is for presenting images and videos, including an image that can include a graphical user interface to a user of the head-wearable apparatus 116.

The image display driver 1020 commands and controls the image display of optical assembly 1018. The image display driver 1020 may deliver image data directly to the image display of optical assembly 1018 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 1028 (e.g., touch sensor or push button), including an input surface on the head-wearable apparatus 116. The user input device 1028 (e.g., touch sensor or push button) is to receive from the user an input selection to manipulate the graphical user interface of the presented image.

The components shown in FIG. 10 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 1006 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 1002, which stores instructions to perform a subset or all of the functions described herein. The memory 1002 can also include storage device.

As shown in FIG. 10, the high-speed circuitry 1026 includes a high-speed processor 1030, a memory 1002, and high-speed wireless circuitry 1032. In some examples, the image display driver 1020 is coupled to the high-speed circuitry 1026 and operated by the high-speed processor 1030 in order to drive the left and right image displays of the image display of optical assembly 1018. The high-speed processor 1030 may be any processor capable of managing high-speed communications and operation of any general computing system needed for the head-wearable apparatus 116. The high-speed processor 1030 includes processing resources needed for managing high-speed data transfers on a high-speed wireless connection 1014 to a wireless local area network (WLAN) using the high-speed wireless circuitry 1032. In certain examples, the high-speed processor 1030 executes an operating system such as a LINUX operating system or other such operating system of the head-wearable apparatus 116, and the operating system is stored in the memory 1002 for execution. In addition to any other responsibilities, the high-speed processor 1030 executing a software architecture for the head-wearable apparatus 116 is used to manage data transfers with high-speed wireless circuitry 1032. In certain examples, the high-speed wireless circuitry 1032 is configured to implement Institute of Electrical and Electronic Engineers (IEEE) 802.11 communication standards, also referred to herein as WI-FI®. In some examples, other high-speed communications standards may be implemented by the high-speed wireless circuitry 1032.

The low-power wireless circuitry 1034 and the high-speed wireless circuitry 1032 of the head-wearable apparatus 116 can include short-range transceivers (Bluetooth™) and wireless wide, local, or wide area network transceivers (e.g., cellular or WI-FI®). Mobile device 114, including the transceivers communicating via the low-power wireless connection 1012 and the high-speed wireless connection 1014, may be implemented using details of the architecture of the head-wearable apparatus 116, as can other elements of the network 1016.

The memory 1002 includes any storage device capable of storing various data and applications, including, among other things, camera data generated by the left and right visible light cameras 1006, the infrared camera 1010, and the image processor 1022, as well as images generated for display by the image display driver 1020 on the image displays of the image display of optical assembly 1018. While the memory 1002 is shown as integrated with high-speed circuitry 1026, in some examples, the memory 1002 may be an independent standalone element of the head-wearable apparatus 116. In certain such examples, electrical routing lines may provide a connection through a chip that includes the high-speed processor 1030 from the image processor 1022 or the low-power processor 1036 to the memory 1002. In some examples, the high-speed processor 1030 may manage addressing of the memory 1002 such that the low-power processor 1036 will boot the high-speed processor 1030 any time that a read or write operation involving memory 1002 is needed.

As shown in FIG. 10, the low-power processor 1036 or high-speed processor 1030 of the head-wearable apparatus 116 can be coupled to the camera (visible light camera 1006, infrared emitter 1008, or infrared camera 1010), the image display driver 1020, the user input device 1028 (e.g., touch sensor or push button), and the memory 1002.

The head-wearable apparatus 116 is connected to a host computer. For example, the head-wearable apparatus 116 is paired with the mobile device 114 via the high-speed wireless connection 1014 or connected to the server system 1004 via the network 1016. The server system 1004 may be one or more computing devices as part of a service or network computing system, for example, that includes a processor, a memory, and network communication interface to communicate over the network 1016 with the mobile device 114 and the head-wearable apparatus 116.

The mobile device 114 includes a processor and a network communication interface coupled to the processor. The network communication interface allows for communication over the network 1016, low-power wireless connection 1012, or high-speed wireless connection 1014. Mobile device 114 can further store at least portions of the instructions in the mobile device 114's memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 1020. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 1004, such as the user input device 1028, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include biometric sensors, additional sensors, or display elements integrated with the head-wearable apparatus 116. For example, peripheral device elements may include any I/O components including output components, motion components, position components, or any other such elements described herein.

For example, the biometric components include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 1012 and high-speed wireless connection 1014 from the mobile device 114 via the low-power wireless circuitry 1034 or high-speed wireless circuitry 1032.

### Machine Architecture

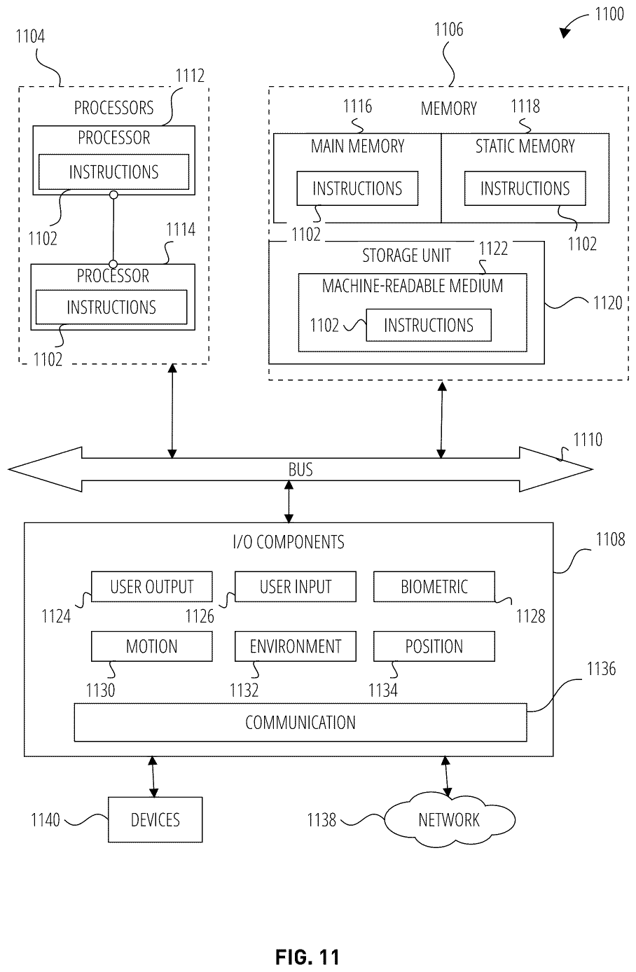

FIG. 11 is a diagrammatic representation of the machine 1100 within which instructions 1102 (e.g., software, a program, an application, an applet, an app, or other executable code) for causing the machine 1100 to perform any one or more of the methodologies discussed herein may be executed. For example, the instructions 1102 may cause the machine 1100 to execute any one or more of the methods described herein. The instructions 1102 transform the general, non-programmed machine 1100 into a particular machine 1100 programmed to carry out the described and illustrated functions in the manner described. The machine 1100 may operate as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1102, sequentially or otherwise, that specify actions to be taken by the machine 1100. Further, while a single machine 1100 is illustrated, the term “machine” shall also be taken to include a collection of machines that individually or jointly execute the instructions 1102 to perform any one or more of the methodologies discussed herein. The machine 1100, for example, may comprise the user system 102 or any one of multiple server devices forming part of the interaction server system 110. In some examples, the machine 1100 may also comprise both client and server systems, with certain operations of a particular method or algorithm being performed on the server-side and with certain operations of the particular method or algorithm being performed on the client-side.

The machine 1100 may include processors 1104, memory 1106, and input/output I/O components 1108, which may be configured to communicate with each other via a bus 1110. In an example, the processors 1104 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1112 and a processor 1114 that execute the instructions 1102. The term “processor” is intended to include multi-core processors that may comprise two or more independent processors (sometimes referred to as “cores”) that may execute instructions contemporaneously. Although FIG. 11 shows multiple processors 1104, the machine 1100 may include a single processor with a single-core, a single processor with multiple cores (e.g., a multi-core processor), multiple processors with a single core, multiple processors with multiples cores, or any combination thereof.

The memory 1106 includes a main memory 1116, a static memory 1118, and a storage unit 1120, both accessible to the processors 1104 via the bus 1110. The main memory 1106, the static memory 1118, and storage unit 1120 store the instructions 1102 embodying any one or more of the methodologies or functions described herein. The instructions 1102 may also reside, completely or partially, within the main memory 1116, within the static memory 1118, within machine-readable medium 1122 within the storage unit 1120, within at least one of the processors 1104 (e.g., within the processor's cache memory), or any suitable combination thereof, during execution thereof by the machine 1100.

The I/O components 1108 may include a wide variety of components to receive input, provide output, produce output, transmit information, exchange information, capture measurements, and so on. The specific I/O components 1108 that are included in a particular machine will depend on the type of machine. For example, portable machines such as mobile phones may include a touch input device or other such input mechanisms, while a headless server machine will likely not include such a touch input device. It will be appreciated that the I/O components 1108 may include many other components that are not shown in FIG. 11. In various examples, the I/O components 1108 may include user output components 1124 and user input components 1126. The user output components 1124 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1126 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1108 may include biometric components 1128, motion components 1130, environmental components 1132, or position components 1134, among a wide array of other components. For example, the biometric components 1128 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like.

The motion components 1130 include acceleration sensor components (e.g., accelerometer), gravitation sensor components, rotation sensor components (e.g., gyroscope).

The environmental components 1132 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gasses for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 1134 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1108 further include communication components 1136 operable to couple the machine 1100 to a network 1138 or devices 1140 via respective coupling or connections. For example, the communication components 1136 may include a network interface component or another suitable device to interface with the network 1138. In further examples, the communication components 1136 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1140 may be another machine or any of a wide variety of peripheral devices (e.g., a peripheral device coupled via a USB).

Moreover, the communication components 1136 may detect identifiers or include components operable to detect identifiers. For example, the communication components 1136 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1136, such as location via Internet Protocol (IP) geolocation, location via Wi-Fi® signal triangulation, location via detecting an NFC beacon signal that may indicate a particular location, and so forth.

The various memories (e.g., main memory 1116, static memory 1118, and memory of the processors 1104) and storage unit 1120 may store one or more sets of instructions and data structures (e.g., software) embodying or used by any one or more of the methodologies or functions described herein. These instructions (e.g., the instructions 1102), when executed by processors 1104, cause various operations to implement the disclosed examples.

The instructions 1102 may be transmitted or received over the network 1138, using a transmission medium, via a network interface device (e.g., a network interface component included in the communication components 1136) and using any one of several well-known transfer protocols (e.g., hypertext transfer protocol (HTTP)). Similarly, the instructions 1102 may be transmitted or received using a transmission medium via a coupling (e.g., a peer-to-peer coupling) to the devices 1140.

### Software Architecture

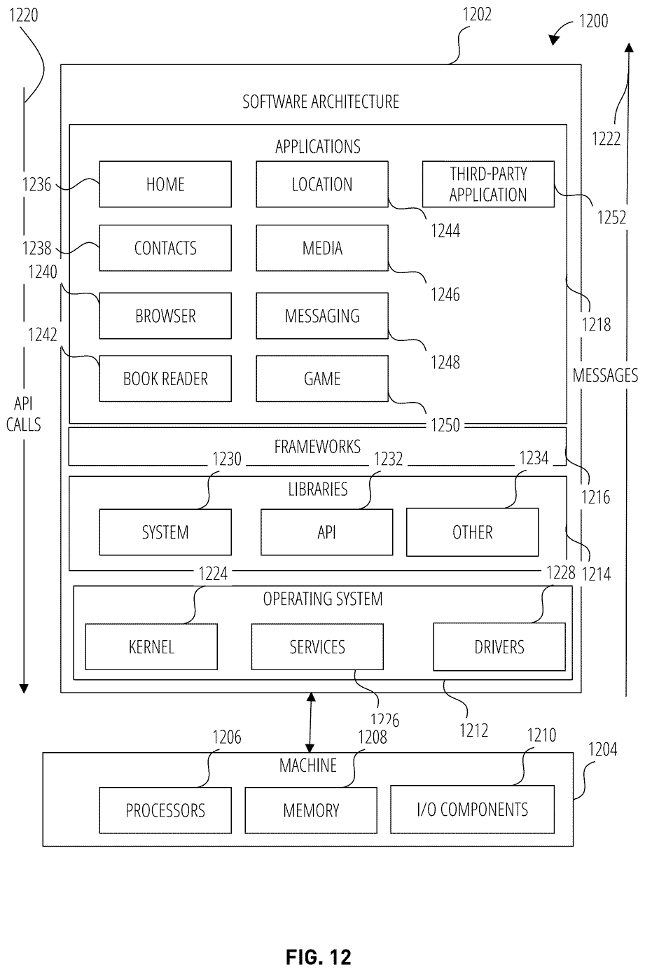

FIG. 12 is a block diagram 1200 illustrating a software architecture 1202, which can be installed on any one or more of the devices described herein. The software architecture 1202 is supported by hardware such as a machine 1204 that includes processors 1206, memory 1208, and I/O components 1210. In this example, the software architecture 1202 can be conceptualized as a stack of layers, where each layer provides a particular functionality. The software architecture 1202 includes layers such as an operating system 1212, libraries 1214, frameworks 1216, and applications 1218. Operationally, the applications 1218 invoke API calls 1220 through the software stack and receive messages 1222 in response to the API calls 1220.

The operating system 1212 manages hardware resources and provides common services. The operating system 1212 includes, for example, a kernel 1224, services 1226, and drivers 1228. The kernel 1224 acts as an abstraction layer between the hardware and the other software layers. For example, the kernel 1224 provides memory management, processor management (e.g., scheduling), component management, networking, and security settings, among other functionalities. The services 1226 can provide other common services for the other software layers. The drivers 1228 are responsible for controlling or interfacing with the underlying hardware. For instance, the drivers 1228 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1214 provide a common low-level infrastructure used by the applications 1218. The libraries 1214 can include system libraries 1230 (e.g., C standard library) that provide functions such as memory allocation functions, string manipulation functions, mathematic functions, and the like. In addition, the libraries 1214 can include API libraries 1232 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1214 can also include a wide variety of other libraries 1234 to provide many other APIs to the applications 1218.

The frameworks 1216 provide a common high-level infrastructure that is used by the applications 1218. For example, the frameworks 1216 provide various graphical user interface (GUI) functions, high-level resource management, and high-level location services. The frameworks 1216 can provide a broad spectrum of other APIs that can be used by the applications 1218, some of which may be specific to a particular operating system or platform.

In an example, the applications 1218 may include a home application 1236, a contacts application 1238, a browser application 1240, a book reader application 1242, a location application 1244, a media application 1246, a messaging application 1248, a game application 1250, and a broad assortment of other applications such as a third-party application 1252. The applications 1218 are programs that execute functions defined in the programs. Various programming languages can be employed to create one or more of the applications 1218, structured in a variety of manners, such as object-oriented programming languages (e.g., Objective-C, Java, or C++) or procedural programming languages (e.g., C or assembly language). In a specific example, the third-party application 1252 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1252 can invoke the API calls 1220 provided by the operating system 1212 to facilitate functionalities described herein.

### Machine-Learning Pipeline

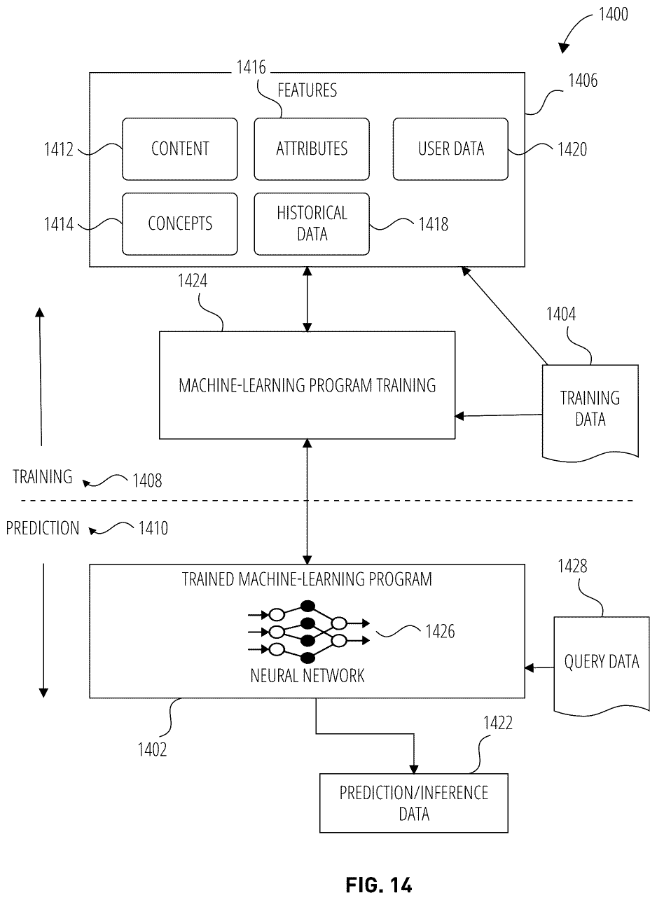

FIG. 14 is a flowchart depicting a machine-learning pipeline 1400, according to some examples. The machine-learning pipelines 1400 may be used to generate a trained model, for example the trained machine-learning program 1402 of FIG. 14, described herein to perform operations associated with searches and query responses.

### Overview

Broadly, machine learning may involve using computer algorithms to automatically learn patterns and relationships in data, potentially without the need for explicit programming to do so after the algorithm is trained. Examples of machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes'theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data. Evaluating the model on a separate test set helps to mitigate the risk of overfitting, a common issue in machine learning where a model learns to perform exceptionally well on the training data but fails to maintain that performance on data it hasn't encountered before. By using a test set, the system obtains a more reliable estimate of the model's real-world performance and its potential effectiveness when deployed in practical applications.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

### Phases

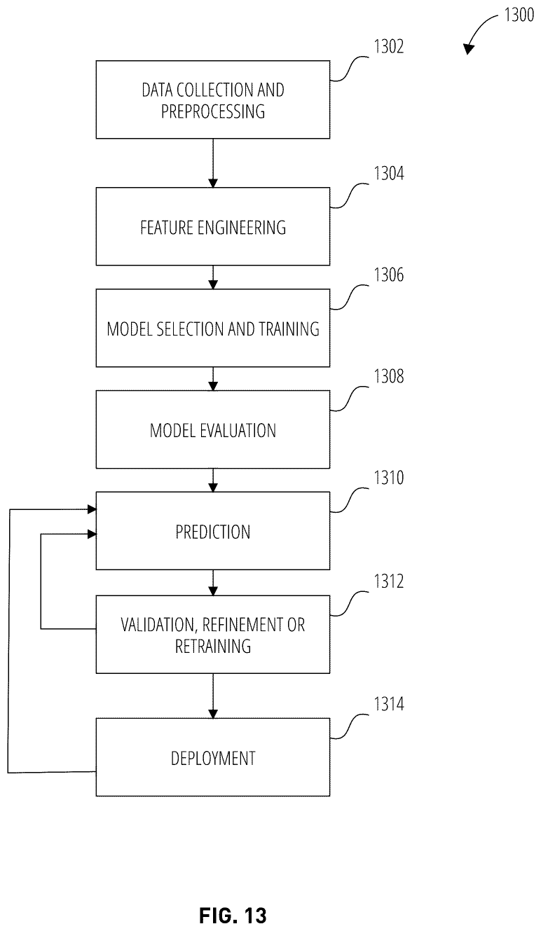

Generating a trained machine-learning program 1402 may include multiple types of phases that form part of the machine-learning pipeline 1400, including for example the following phases 1300 illustrated in FIG. 13:
Data collection and preprocessing 1302: This may include acquiring and cleaning

data to ensure that it is suitable for use in the machine learning model. Data can be gathered from user content creation and labeled using a machine learning algorithm trained to label data. Data can be generated by applying a machine learning algorithm to identify or generate similar data. This may also include removing duplicates, handling missing values, and converting data into a suitable format.
Feature engineering 1304: This may include selecting and transforming the training data 1404 to create features that are useful for predicting the target variable. Feature engineering may include (1) receiving features 1406 (e.g., as structured or labeled data in supervised learning) and/or (2) identifying features 1406 (e.g., unstructured or unlabeled data for unsupervised learning) in training data 1404.
Model selection and training 1306: This may include specifying a particular problem or desired response from input data, selecting an appropriate machine learning algorithm, and training it on the preprocessed data. This may further involve splitting the data into training and testing sets, using cross-validation to evaluate the model, and tuning hyperparameters to improve performance. Model selection can be based on factors such as the type of data, problem complexity, computational resources, or desired performance.
Model evaluation 1308: This may include evaluating the performance of a trained model (e.g., the trained machine-learning program 1402) on a separate testing dataset. This can help determine if the model is overfitting or underfitting and if it is suitable for deployment.
Prediction 1310: This involves using a trained model (e.g., trained machine-learning program 1402) to generate predictions on new, unseen data.
Validation, refinement or retraining 1312: This may include updating a model based on feedback generated from the prediction phase, such as new data or user feedback.
Deployment 1314: This may include integrating the trained model (e.g., the trained machine-learning program 1402) into a larger system or application, such as a web service, mobile app, or IoT device. This can involve setting up APIs, building a user interface, and ensuring that the model is scalable and can handle large volumes of data.

FIG. 14 illustrates two example phases, namely a training phase 1408 (part of the model selection and trainings 1306) and a prediction phase 1410 (part of prediction 1310). Prior to the training phase 1408, feature engineering 1304 is used to identify features 1406. This may include identifying informative, discriminating, and independent features for the effective operation of the trained machine-learning program 1402 in pattern recognition, classification, and regression. In some examples, the training data 1404 includes labeled data, which is known data for pre-identified features 1406 and one or more outcomes.

Each of the features 1406 may be a variable or attribute, such as individual measurable property of a process, article, system, or phenomenon represented by a data set (e.g., the training data 1404). Features 1406 may also be of different types, such as numeric features, strings, vectors, matrices, encodings, and graphs, and may include one or more of content 1412, concepts 1414, attributes 1416, historical data 1418 and/or user data 1420, merely for example. Concept features can include abstract relationships or patterns in data, such as determining a topic of a document or discussion in a chat window between users. Content features include determining a context based on input information, such as determining a context of a user based on user interactions or surrounding environmental factors. Context features can include text features, such as frequency or preference of words or phrases, image features, such as pixels, textures, or pattern recognition, audio classification, such as spectrograms, and/or the like. Attribute features include intrinsic attributes (directly observable) or extrinsic features (derived), such as identifying square footage, location, or age of a real estate property identified in a camera feed. User data features include data pertaining to a particular individual or to a group of individuals, such as in a geographical location or that share demographic characteristics. User data can include demographic data (such as age, gender, location, or occupation), user behavior (such as browsing history, purchase history, conversion rates, click-through rates, or engagement metrics), or user preferences (such as preferences to certain video, text, or digital content items). Historical data includes past events or trends that can help identify patterns or relationships over time.

In training phases 1408, the machine-learning pipeline 1400 uses the training data 1404 to find correlations among the features 1406 that affect a predicted outcome or prediction/inference data 1422.

With the training data 1404 and the identified features 1406, the trained machine-learning program 1402 is trained during the training phase 1408 during machine-learning program training 1424. The machine-learning program training 1424 appraises values of the features 1406 as they correlate to the training data 1404. The result of the training is the trained machine-learning program 1402 (e.g., a trained or learned model).

Further, the training phase 1408 may involve machine learning, in which the training data 1404 is structured (e.g., labeled during preprocessing operations), and the trained machine-learning program 1402 implements a relatively simple neural network 1426 capable of performing, for example, classification and clustering operations. In other examples, the training phase 1408 may involve deep learning, in which the training data 1404 is unstructured, and the trained machine-learning program 1402 implements a deep neural network 1426 that is able to perform both feature extraction and classification/clustering operations.

A neural network 1426 may, in some examples, be generated during the training phase 1408, and implemented within the trained machine-learning program 1402. The neural network 1426 includes a hierarchical (e.g., layered) organization of neurons, with each layer including multiple neurons or nodes. Neurons in the input layer receive the input data, while neurons in the output layer produce the final output of the network. Between the input and output layers, there may be one or more hidden layers, each including multiple neurons.

Each neuron in the neural network 1426 operationally computes a small function, such as an activation function that takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, which can affect their performance on different tasks. Overall, the layered organization of neurons and the use of activation functions and weights enable neural networks to model complex relationships between inputs and outputs, and to generalize to new inputs that were not seen during training.

In some examples, the neural network 1426 may also be one of a number of different types of neural networks or a combination thereof, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 1408, a validation phase may be performed evaluated on a separate dataset known as the validation dataset. The validation dataset is used to tune the hyperparameters of a model, such as the learning rate and the regularization parameter. The hyperparameters are adjusted to improve the performance of the model on the validation dataset.

The neural network 1426 is iteratively trained by adjusting model parameters to minimize a specific loss function or maximize a certain objective. The system can continue to train the neural network 1426 by adjusting parameters based on the output of the validation, refinement, or retraining block 1312, and rerun the prediction 1310 on new or already run training data. The system can employ optimization techniques for these adjustments such as gradient descent algorithms, momentum algorithms, Nesterov Accelerated Gradient (NAG) algorithm, and/or the like. The system can continue to iteratively train the neural network 1426 even after deployment 1314 of the neural network 1426. The neural network 1426 can be continuously trained as new data emerges, such as based on user creation or system-generated training data.

Once a model is fully trained and validated, in a testing phase, the model may be tested on a new dataset that the model has not seen before. The testing dataset is used to evaluate the performance of the model and to ensure that the model has not overfit the training data.

In prediction phase 1410, the trained machine-learning program 1402 uses the features 1406 for analyzing query data 1428 to generate inferences, outcomes, or predictions, as examples of a prediction/inference data 1422. For example, during prediction phase 1410(the trained machine-learning program 1402 is used to generate an output. Query data 1428 is provided as an input to the trained machine-learning program 1402, and the trained machine-learning program 1402 generates the prediction/inference data 1422 as output, responsive to receipt of the query data 1428. Query data can include a prompt, such as a user entering a textual question or speaking a question audibly. In some cases, the system generates the query based on an interaction function occurring in the system, such as a user interacting with a virtual object, a user sending another user a question in a chat window, or an object detected in a camera feed.

In some examples the trained machine-learning program 1402 may be a generative AI model. Generative AI is a term that may refer to any type of artificial intelligence that can create new content from training data 1404. For example, generative AI can produce text, images, video, audio, code or synthetic data that are similar to the original data but not identical.

Some of the techniques that may be used in generative AI are:
Convolutional Neural Networks (CNNs): CNNs are commonly used for image recognition and computer vision tasks. They are designed to extract features from images by using filters or kernels that scan the input image and highlight important patterns. CNNs may be used in applications such as object detection, facial recognition, and autonomous driving.
Recurrent Neural Networks (RNNs): RNNs are designed for processing sequential data, such as speech, text, and time series data. They have feedback loops that allow them to capture temporal dependencies and remember past inputs. RNNs may be used in applications such as speech recognition, machine translation, and sentiment analysis
Generative adversarial networks (GANs): These are models that consist of two neural networks: a generator and a discriminator. The generator tries to create realistic content that can fool the discriminator, while the discriminator tries to distinguish between real and fake content. The two networks compete with each other and improve over time. GANs may be used in applications such as image synthesis, video prediction, and style transfer.
Variational autoencoders (VAEs): These are models that encode input data into a latent space (a compressed representation) and then decode it back into output data. The latent space can be manipulated to generate new variations of the output data. They may use self-attention mechanisms to process input data, allowing them to handle long sequences of text and capture complex dependencies.
Transformer models: These are models that use attention mechanisms to learn the relationships between different parts of input data (such as words or pixels) and generate output data based on these relationships. Transformer models can handle sequential data such as text or speech as well as non-sequential data such as images or code.

In generative AI examples, the prediction/inference data 1422 that is output include trend assessment and predictions, translations, summaries, image or video recognition and categorization, natural language processing, face recognition, user sentiment assessments, advertisement targeting and optimization, voice recognition, or media content generation, recommendation, and personalization.

### EXAMPLES

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one processor; and at least one memory component storing instructions that, when executed by the at least one processor, cause the at least one processor to perform operations comprising: determining an initiation of an interaction function by a first user of an interaction system with a second user of the interaction system; accessing first avatar data associated with a first user that includes, one or more visual attributes of a first avatar associated with the first user and a first garment of the first avatar; accessing second avatar data associated with a second user that includes one or more visual attributes of a second avatar associated with the second user and a second garment of the second avatar; generating an image of the first avatar wearing the first garment with the second avatar wearing the second garment; applying the image onto the first garment to generate a modified first garment; and displaying the first avatar wearing the modified first garment with the second avatar wearing the second garment.

In Example 2, the subject matter of Example 1 includes, wherein the operations further comprise: identifying a particular type of relationship between the first user and the second user; and accessing the second avatar data associated with the second user based on the identified type of relationship.

In Example 3, the subject matter of Example 2 includes, wherein the operations further comprise: designating the type of relationship between the first and second users based on other interaction functions between the first and second user beyond the initiation of the interaction function.

In Example 4, the subject matter of Examples 1-3 includes, wherein applying the image onto the first garment includes: determining a mesh of the first garment; and applying the image as a texture onto the mesh of the first garment to generate a modified first garment.

In Example 5, the subject matter of Examples 1-4 includes, wherein the operations further comprise: applying data corresponding to an interaction between the first user and the second user based on the interaction function into a machine learning model; retrieving contextual information of the interaction from the machine learning model; and modifying the image based on the contextual information received from the machine learning model, wherein applying the image onto the first garment comprises applying the modified image onto the first garment.

In Example 6, the subject matter of Example 5 includes, wherein the machine learning model comprises a generative machine learning model trained to generate the image based on the contextual information.

In Example 7, the subject matter of Examples 5-6 includes, wherein the contextual information includes a sentiment analysis to identify a sentiment of the interaction between the first and second user, wherein the modified image reflects the sentiment of the interaction between the first and second user.

In Example 8, the subject matter of Examples 5-7 includes, wherein the interaction function includes a messaging system between the first and second user, wherein the displaying of the first avatar wearing the modified first garment with the second avatar wearing the second garment comprises displaying the first avatar wearing the modified first garment with the second avatar wearing the second garment on the messaging system.

In Example 9, the subject matter of Examples 5-8 includes, wherein the interaction function includes a messaging system among a group of users that includes at least the first user, the second user, and a third user, wherein the machine learning model identifies contextual information based on messages sent between the first, second, and third user, wherein the modified image indicates an activity discussed within the contextual information.

In Example 10, the subject matter of Examples 1-9 includes, wherein the operations further comprise applying data corresponding to an interaction between the first user and the second user based on the interaction function into a machine learning model, wherein generating the image of the first avatar wearing the first garment with the second avatar wearing the second garment comprises receiving the image of the first avatar wearing the first garment with the second avatar wearing the second garment from the machine learning model, the machine learning model trained to generate the image based on the inputted data corresponding to the interaction.

In Example 11, the subject matter of Example 10 includes, wherein the machine learning model generates a design of the image automatically based on past user preferences stored in corresponding user profiles.

In Example 12, the subject matter of Examples 10-11 includes, wherein the machine learning model generates a design of the image automatically based on recent real-world activities between the first and second user identified in the interaction.

In Example 13, the subject matter of Examples 1-12 includes, wherein the operations further comprise: identifying a first location of the first user based on GPS coordinates of a first computing device and a second location of the second user based on GPS coordinates of a second computing device; and determining whether the first location is within a certain distance threshold of the second location; wherein displaying the first avatar wearing the modified first garment with the second avatar wearing the second garment is in response to determining that the first location is within the certain distance threshold of the second location.

In Example 14, the subject matter of Examples 1-13 includes, wherein the operations further comprise: identifying a first location of the first user based on GPS coordinates of a first computing device; and determining that the first location is within a certain distance threshold of a second location corresponding to a merchant; wherein generating the image comprises identifying a good or service provided by the merchant and displaying the good or service in the image with the first and second avatars.

In Example 15, the subject matter of Examples 1-14 includes, wherein displaying the first avatar wearing the modified first garment with the second avatar wearing the second garment comprises applying a content augmentation of the image to a live camera feed from a camera system; and displaying the live camera feed with the applied content augmentation to the first user.

In Example 16, the subject matter of Examples 1-15 includes, wherein the operations further comprise: identifying a past activity performed by the first user and a second user; and adding one or more contextual elements to the image that corresponds to the past activity.

In Example 17, the subject matter of Examples 1-16 includes, wherein the operations further comprise: transmitting data corresponding to the image of the first avatar wearing the first garment with the second avatar wearing the second garment to a third party server causing the third party server to initiate the manufacturing of the first garment in real life for the first user.

Example 18 is a method comprising: determining an initiation of an interaction function by a first user of an interaction system with a second user of the interaction system; accessing first avatar data associated with a first user that includes, one or more visual attributes of a first avatar associated with the first user and a first garment of the first avatar; accessing second avatar data associated with a second user that includes one or more visual attributes of a second avatar associated with the second user and a second garment of the second avatar; generating an image of the first avatar wearing the first garment with the second avatar wearing the second garment; applying the image onto the first garment to generate a modified first garment; and displaying the first avatar wearing the modified first garment with the second avatar wearing the second garment.

In Example 19, the subject matter of Example 18 includes, wherein the operations further comprise: identifying a particular type of relationship between the first user and the second user; and accessing the second avatar data associated with the second user based on the identified type of relationship.

Example 20 is a non-transitory computer-readable storage medium storing instructions that, when executed by at least one processor, cause the at least one processor to perform operations comprising: determining an initiation of an interaction function by a first user of an interaction system with a second user of the interaction system; accessing first avatar data associated with a first user that includes, one or more visual attributes of a first avatar associated with the first user and a first garment of the first avatar; accessing second avatar data associated with a second user that includes one or more visual attributes of a second avatar associated with the second user and a second garment of the second avatar; generating an image of the first avatar wearing the first garment with the second avatar wearing the second garment; applying the image onto the first garment to generate a modified first garment; and displaying the first avatar wearing the modified first garment with the second avatar wearing the second garment.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

### Conclusion

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

What is claimed is:

1. A system comprising:
at least one processor; and
at least one memory component storing instructions that, when executed by the at least one processor, cause the at least one processor to perform operations comprising:
determining an initiation of an interaction function by a first user of an interaction system with a second user of the interaction system;
accessing first avatar data associated with a first user that includes one or more visual attributes of a first avatar associated with the first user and a first garment of the first avatar;
accessing second avatar data associated with a second user that includes one or more visual attributes of a second avatar associated with the second user and a second garment of the second avatar;
generating an image of the first avatar wearing the first garment with the second avatar wearing the second garment;
applying the image onto the first garment to generate a modified first garment; and
displaying the first avatar wearing the modified first garment with the second avatar wearing the second garment.

2. The system of claim 1, wherein the operations further comprise:
identifying a particular type of relationship between the first user and the second user; and
accessing the second avatar data associated with the second user based on the identified type of relationship.

3. The system of claim 2, wherein the operations further comprise:
designating the type of relationship between the first and second users based on other interaction functions between the first and second user beyond the initiation of the interaction function.

4. The system of claim 1, wherein applying the image onto the first garment includes:
determining a mesh of the first garment; and
applying the image as a texture onto the mesh of the first garment to generate a modified first garment.

5. The system of claim 1, wherein the operations further comprise:
applying data corresponding to an interaction between the first user and the second user based on the interaction function into a machine learning model;
retrieving contextual information of the interaction from the machine learning model; and
modifying the image based on the contextual information received from the machine learning model,
wherein applying the image onto the first garment comprises applying the modified image onto the first garment.

6. The system of claim 5, wherein the machine learning model comprises a generative machine learning model trained to generate the image based on the contextual information.

7. The system of claim 5, wherein the contextual information includes a sentiment analysis to identify a sentiment of the interaction between the first and second user, wherein the modified image reflects the sentiment of the interaction between the first and second user.

8. The system of claim 5, wherein the interaction function includes a messaging system between the first and second user, wherein the displaying of the first avatar wearing the modified first garment with the second avatar wearing the second garment comprises displaying the first avatar wearing the modified first garment with the second avatar wearing the second garment on the messaging system.

9. The system of claim 5, wherein the interaction function includes a messaging system among a group of users that includes at least the first user, the second user, and a third user, wherein the machine learning model identifies contextual information based on messages sent between the first, second, and third user, wherein the modified image indicates an activity discussed within the contextual information.

10. The system of claim 1, wherein the operations further comprise inputting data corresponding to an interaction between the first user and the second user based on the interaction function into a machine learning model, wherein generating the image of the first avatar wearing the first garment with the second avatar wearing the second garment comprises receiving the image of the first avatar wearing the first garment with the second avatar wearing the second garment from the machine learning model, the machine learning model trained to generate the image based on the inputted data corresponding to the interaction.

11. The system of claim 10, wherein the machine learning model generates a design of the image automatically based on past user preferences stored in corresponding user profiles.

12. The system of claim 10, wherein the machine learning model generates a design of the image automatically based on recent real-world activities between the first and second user identified in the interaction.

13. The system of claim 1, wherein the operations further comprise:
identifying a first location of the first user based on GPS coordinates of a first computing device and a second location of the second user based on GPS coordinates of a second computing device; and
determining whether the first location is within a certain distance threshold of the second location;
wherein displaying the first avatar wearing the modified first garment with the second avatar wearing the second garment is in response to determining that the first location is within the certain distance threshold of the second location.

14. The system of claim 1, wherein the operations further comprise:
identifying a first location of the first user based on GPS coordinates of a first computing device; and
determining that the first location is within a certain distance threshold of a second location corresponding to a merchant;
wherein generating the image comprises identifying a good or service provided by the merchant and displaying the good or service in the image with the first and second avatars.

15. The system of claim 1, wherein displaying the first avatar wearing the modified first garment with the second avatar wearing the second garment comprises applying a content augmentation of the image to a live camera feed from a camera system; and displaying the live camera feed with the applied content augmentation to the first user.

16. The system of claim 1, wherein the operations further comprise:
identifying a past activity performed by the first user and a second user; and
adding one or more contextual elements to the image that corresponds to the past activity.

17. The system of claim 1, wherein the operations further comprise:
transmitting data corresponding to the image of the first avatar wearing the first garment with the second avatar wearing the second garment to a third party server causing the third party server to initiate manufacturing of the first garment in real life for the first user.

18. A method comprising:
determining an initiation of an interaction function by a first user of an interaction system with a second user of the interaction system;
accessing first avatar data associated with a first user that includes one or more visual attributes of a first avatar associated with the first user and a first garment of the first avatar;
accessing second avatar data associated with a second user that includes one or more visual attributes of a second avatar associated with the second user and a second garment of the second avatar;
generating an image of the first avatar wearing the first garment with the second avatar wearing the second garment;
applying the image onto the first garment to generate a modified first garment; and
displaying the first avatar wearing the modified first garment with the second avatar wearing the second garment.

19. The method of claim 18, further comprising:
identifying a particular type of relationship between the first user and the second user; and
accessing the second avatar data associated with the second user based on the identified type of relationship.

20. A non-transitory computer-readable storage medium storing instructions that, when executed by at least one processor, cause the at least one processor to perform operations comprising:
determining an initiation of an interaction function by a first user of an interaction system with a second user of the interaction system;
accessing first avatar data associated with a first user that includes one or more visual attributes of a first avatar associated with the first user and a first garment of the first avatar;
accessing second avatar data associated with a second user that includes one or more visual attributes of a second avatar associated with the second user and a second garment of the second avatar;
generating an image of the first avatar wearing the first garment with the second avatar wearing the second garment;
applying the image onto the first garment to generate a modified first garment; and
displaying the first avatar wearing the modified first garment with the second avatar wearing the second garment.
